(19) United States
(12) Patent Application Publication
(10) Pub. No.: US 2014/0188579 A1
(43) Pub. Date: Jul. 3, 2014

(54) Electronic Toll and Weigh Station Bypass Systems

(71) Applicant: CDM Smith Inc., Cambridge, MA (US)

(72) Inventors: Edward J. Regan, III, Blythewood, SC (US); Kris N. Wuestefeld, Woodbridge, CT (US); Sergio D. Reis, Syosset, NY (US); Robert E. Wayson, Chapin, SC (US)

(73) Assignee: CDM Smith Inc., Cambridge, MA (US)

(21) Appl. No.: 14/139,090

(22) Filed: Dec. 23, 2013

Related U.S. Application Data
(60) Provisional application No. 61/745,972, filed on Dec. 26, 2012.

(51) Int. Cl. G07B 15/06

(52) U.S. Cl. CPC G07B 15/063
USPC 705/13

(57) ABSTRACT

Transportation services may provide nationwide tolling interoperability. Multi-agency electronic tolling transponders each compatible with multiple tolling agencies are provided to clients. The multi-agency transponders are linked to respective accounts associated with the clients. Transponder tolling data for respective clients is obtained from the multiple tolling agencies. Payments may be sent to each agency corresponding to the clients' respective transponder tolling data and the clients may be billed based upon the transponder tolling data.

### RELATED APPLICATION

This application claims the benefit of U.S. Provisional Application No. 61/745,972, filed on Dec. 26, 2012. The entire teachings of the above application are incorporated herein by reference.

### BACKGROUND OF THE INVENTION

There are hundreds of toll facilities operated by more than five dozen public and/or private agencies in the U.S. and Canada. Almost all of these facilities now employ electronic toll collection (ETC), generally involving establishment of a pre-paid account and having vehicles equipped with small electronic transponder devices typically on the windshield. Motorists equipped with ETC can often pass through tolling points without the need to pay cash, and often at full freeway speed. Today, there are approximately 40 million vehicles equipped with electronic toll transponders, and ETC transactions now comprise as much as three-fourths of total traffic at toll collection points nationwide.

Most toll facilities still offer cash collection, in addition to electronic collection. However, some facilities, both existing and new toll roads, are shifting to fully “cashless” all electronic tolling (AET). Motorists with ETC are processed electronically, but vehicles without transponders are tolled by capturing video images of license plates and through mailed billings and collections.

### SUMMARY OF THE INVENTION

Thus, methods of efficiently improving toll collection and highway transportation are needed. A method and corresponding system according to an embodiment of the present invention are directed to providing transportation services.

A method and corresponding system according to certain embodiments of the present invention are directed to providing transportation services. An embodiment of the present invention begins by linking multi-agency electronic toll transponders, each compatible with multiple tolling agencies, to respective accounts associated with clients. Then, obtaining transponder tolling data for respective clients from the multiple tolling agencies. An alternative embodiment further comprises providing the multi-agency tolling transponders to the clients. In an alternative embodiment of the present invention, the method further comprises sending payments to each agency corresponding to the clients' respective transponder tolling data and billing the clients based upon the transponder tolling data. According to yet another embodiment of the present invention, the multi-agency compatible electronic tolling transponders are capable of communication via multiple protocols.

An alternative embodiment of the present invention further comprises obtaining the clients' respective geo-positional tolling data from respective geo-positional tracking devices. Further, such an embodiment also comprises comparing the respective geo-positional tolling data and the respective transponder tolling data, and/or reconciling the respective geo-positional tolling data and respective transponder tolling data. According to an embodiment of the present invention, reconciling the respective geo-positional tolling data and the respective transponder tolling data comprises at least one of: notifying the clients when the respective geo-positional tolling data and the respective transponder data do not correspond and notifying each agency when the respective geo-positional tolling data and the respective transponder tolling data do not correspond. According to yet another embodiment of the present invention, obtaining the clients' geo-positional tolling data comprises communicating with transportation management systems associated with the clients.

In another embodiment, clients are billed for tolling based upon respective geo-positional tolling data. In such an embodiment, the method further comprises obtaining the clients' respective geo-positional tolling data from respective geo-positional tracking devices associated with the clients and billing the clients based upon the respective geo-positional tolling data. Another embodiment of the present invention further provides weigh station by-pass services. An embodiment of the method directed to providing weigh station by-pass further comprises receiving notifications from geo-positional tracking devices that the clients are approaching respective weigh stations. In response to the notifications, sending respective requests to each weigh station for weigh station by-pass, receiving respective responses to each request for weigh station by-pass, and sending each respective response to the respective clients. According to such an embodiment of the present invention, receiving notifications from geo-positional tracking devices that clients are approaching respective weigh stations comprises communicating with transportation management systems associated with the clients.

An alternative embodiment of the present invention is directed to a system for performing transportation services. According to such an embodiment, the system comprises respective accounts linked to multi-agency electronic tolling transponders, each compatible with multiple tolling agencies, associated with clients and a transponder tolling module configured to obtain the clients' respective transponder tolling data from the multiple tolling agencies. According to another embodiment of the system, the system may further comprise a payment module configured to send payment to each agency corresponding to the clients' transponder tolling data and a billing module configured to bill the clients based upon the transponder tolling data. Further, in an embodiment of the system, the multi-agency electronic tolling transponders are capable of communication via multiple protocols.

Another embodiment of the system further provides geo-positional tolling in addition to transponder based tolling. In such an embodiment, the system comprises a geo-positional tolling module configured to obtain the clients' respective geo-positional tolling data from respective geo-positional tracking devices. Further, the system may also comprise a comparison module configured to compare the respective geo-positional tolling data and the respective transponder tolling data and/or a reconciling module configured to reconcile the respective geo-positional tolling data and the respective transponder tolling data. According to an embodiment of the system, the reconciling module is configured to reconcile the respective geo-positional and transponder tolling data by notifying the clients when the respective geo-positional tolling data and the respective transponder tolling data do not correspond and/or notifying each agency when the respective geo-positional tolling data and the respective transponder tolling data do not correspond. According to an embodiment of the system, the geo-positional tolling module may be configured to obtain the clients geo-positional tolling data by communicating with transportation management systems associated with the clients.

An alternative embodiment the system bills clients based upon geo-positional tolling. In such an embodiment, the system comprises a geo-positional tolling module configured to obtain the clients' respective geo-positional tolling data from respective geo-positional tracking devices and a billing module configured to bill the clients based upon the respective geo-positional tolling data.

Similarly to methods of the present invention described hereinabove, an embodiment of the system may provide weigh station by-pass services. In such an embodiment, the system further comprises an approach notification module configured to receive notifications from respective geo-positional tracking devices that the clients are approaching respective weigh stations. In such an embodiment, the system also comprises a by-pass unit configured to send respective requests to each weigh station requesting weigh station by-pass and the by-pass unit is further configured to receive a respective response to each request for weigh station by-pass and to send each respective response to the respective clients. According to an alternative embodiment of present invention, the approach notification module utilized for weigh station by-pass may be configured to receive the notifications from the respective geo-positional tracking devices by communicating with transportation management systems associated with the clients.

Another embodiment the present invention is directed to a non-transitory computable readable medium having stored thereon a sequence of instructions which, when loaded and executed by a processor coupled to an apparatus, causes the apparatus to carry out embodiments of the present invention. In such an embodiment, the instructions which when loaded and executed by a processor coupled to the apparatus, may cause apparatus to link multi-agency electronic tolling transponders, each compatible with multiple tolling agencies, to respective accounts associated with clients. Further, embodiments the present invention may cause the apparatus to obtain transponder tolling data for respective clients from the multiple tolling agencies. In an alternative embodiment, the sequence of instructions, when loaded and executed by the processor coupled to the apparatus, further causes the apparatus to send payment to each agency corresponding to the clients' transponder tolling data and to bill the clients based upon the transponder tolling data.

In yet another embodiment of the non-transitory capable computer readable medium, the sequence of instructions, when loaded and executed by a processor coupled to the apparatus, further causes the apparatus to: obtain the clients' respective geo-positional tolling data from respective geo-positional tracking devices, compare the respective geo-positional tolling data and respective transponder tolling data, and reconcile the respective geo-positional tolling data and the respective transponder tolling data.

Another embodiment of the non-transitory computer readable medium also provides billing based upon geo-positional tolling. In such an embodiment, the apparatus is further configured to obtain the clients' respective geo-positional tolling data from respective geo-positional tracking devices and bill the clients based upon the respective geo-positional tolling data.

A further embodiment of the present invention is directed to a vehicle. According to such embodiment, the vehicle comprises electronics configured to: store geo-positional locations of tolling points and use the stored geo-positional locations of tolling points to determine the occurrence of tolling events. Further, in such an embodiment, the electronics may be further configured to store data related to the vehicle and use the data related to the vehicle to determine a cost of the tolling events.

A further embodiment of the present invention provides transportation services using transponder tolling data and geo-positional tolling data. In such an embodiment, a method according to the principles of the present invention comprises: linking electronic tolling transponders to respective accounts associated with clients, and obtaining transponder tolling data for the respective clients. Such a method further comprises obtaining the clients' respective geo-positional tolling data from respective geo-positional tracking devices, comparing the respective geo-positional tolling data and the respective transponder tolling data, and reconciling the respective geo-positional tolling data and the respective transponder tolling data.

Another embodiment of the present invention provides transportation services using geo-positional data. According to such an embodiment, a method of the present invention comprises receiving geo-positional data from a transportation management system that communicates with individual vehicles and determining tolling events based upon the received geo-positional data. According to such an embodiment of the present invention, the TMS may receive the geo-positional data from on-board units associated with individual vehicles. In yet another alternative embodiment, weigh station by-pass services are provided. A method for providing weigh station by-pass services according to such an embodiment comprises: receiving notifications from geo-positional tracking devices that clients are approaching respective weigh stations, sending respective requests to each weigh station for weigh station by-pass, receiving a respective response to each request for weigh station by-pass, and sending each respective response to the respective clients. In such an embodiment, the geo-positional tracking devices may be on-board units associated with vehicles.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 depicts typical current methods of electronic toll account structures and regional electronic toll interoperability.

FIG. 2 shows a graphic depiction of the proposed third party toll payment service provider arrangement included in embodiments of the invention.

FIG. 3 shows common electronic toll collection (ETC) protocol zones in the United States and Canada.

FIG. 4 shows an overall system configuration of the truck electronic tolling and weigh station by-pass authorization system addressed by an embodiment of the present invention.

FIG. 5 shows an illustration of typical trucking industry tracking systems, referred to as transportation management systems (TMS) that may be utilized in an embodiment of the invention.

FIG. 6 shows the typical on-board equipment configuration which may be used in truck tolling and weigh station by-pass functions according to embodiments of the invention.

FIG. 7 shows an overall system diagram of an embodiment for an integrated truck toll payment and weigh station by-pass system according to an embodiment of the present invention.

FIG. 8 shows an illustrative parallel toll transaction processing system that may be implemented in an embodiment of the present invention.

FIG. 9 provides a flow diagram for a truck toll processing method according to an embodiment of the invention.

FIG. 10 is a flow diagram for an embodiment of the processing method to be used in toll transaction reconciliation and payment according to principles of the present invention.

FIG. 11 shows a typical “virtual” weigh station by-pass authorization process implementing principles of the present invention.

FIG. 12 shows a flow diagram on how “virtual” weigh station by-pass authorization will operate in embodiments of the invention.

FIG. 13 shows an illustrative typical truck “virtual” trip record, as might be recorded for a truck implementing an embodiment of the present invention.

FIG. 14 provides a system overview of a national rental car virtual tolling system according to the principles of the present invention.

FIG. 15 shows the on-board equipment configuration for a rental car application that is utilized in embodiments of the present invention.

FIG. 16 provides a functional overview diagram of the rental vehicle national tolling system that may be implemented in an embodiment of the invention.

FIG. 17 depicts a process utilized in embodiments of the national rental vehicle tolling system which will occur at the time of car rental.

FIG. 18 shows how random toll transaction messages will be processed during a typical vehicle rental that implements embodiments of the present invention.

FIG. 19 shows actions which may occur with the national rental vehicle tolling system on return of the rental vehicle according to an embodiment of the invention.

FIG. 20 is a flow diagram for a rental cycle, including vehicle rental, toll charge processing and rental vehicle return that may be implemented in an embodiment of the present invention.

FIG. 21 is a flow chart depicting a method of providing transportation services according to an embodiment of the present invention.

FIG. 22 is a simplified block diagram of a computer system in which embodiments of the present invention may be embodied.

### DETAILED DESCRIPTION OF THE INVENTION

A description of example embodiments of the invention follows.

The teachings of all patents, published applications, and references cited herein are incorporated by reference in their entirety.

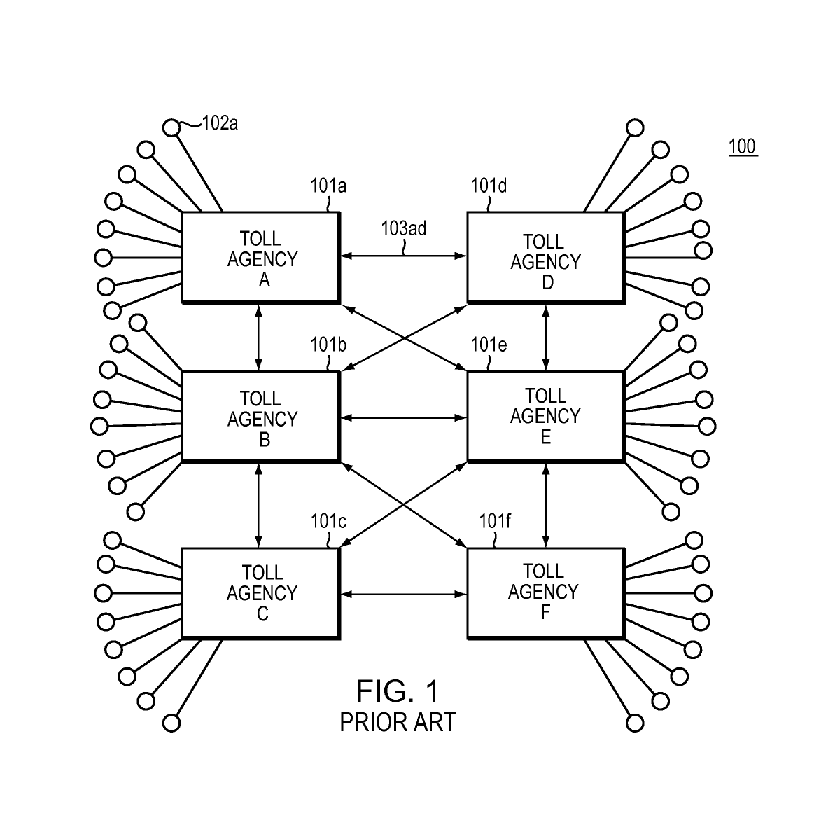

As noted above, the typical electronic toll collection (ETC) process involves the opening of a pre-paid account, and the issuance of an electronic transponder which may be mounted on the vehicle windshield. In the existing ETC process the transponders are issued by individual toll agencies, and customer accounts are “owned” and maintained by these agencies. Some agencies, in different regions of the U.S., have developed interoperability agreements under which they accept each other's transponders for valid toll payment. This traditional relationship for ETC is illustrated in FIG. 1. In the traditional ETC relationship, an individual, such as the individual 102a has a relationship with a tolling agency, such as the tolling agency 101a. Because of this relationship, the individual 102a can utilize ETC in tolls owned by the tolling agency 101a. However, without interoperability agreements, the toll account of the individual 102a cannot be used on facilities operated by other agencies, such as the toll agency 101b. In order to provide interoperability, the agencies 101a-h in such ETC interoperability programs still issue and maintain the individual customer accounts, such as that belonging to the individual 102a, but mutually agree to accept payment products, provide interagency payment guarantees, and exchange information on a “peer-to-peer” basis. For example, the agreement 103ad between the toll agency 101a and the toll agency 101d allows the individual 102a to use ETC in tolls operated by the toll agency 101d in addition to tolls owned and operated by its account holder, the toll agency 101a. The extent of interoperability in this example is limited by the number of interoperability agreements between the toll agencies 101a-h. Such regional interoperability networks exist between toll agencies in the Northeast U.S., Florida, Texas, and California.

The ability to provide complete interoperability however, is limited. As described hereinabove, a user must have a transponder compatible with the tolling agency to be able to utilize ETC. However, in the U.S. and Canada there are actually seven different transponder “protocols” in use. For the most part, transponders of different protocols cannot be read by other types of systems. For example, an EZ-Pass® transponder issued in Pennsylvania can be read in all other states using EZ-Pass®, but cannot be read, for example, in Florida, Texas, or California.

There is a movement to achieve nationwide interoperability; in which a single pre-paid toll account would be accepted at toll facilities across the U.S. The International Bridge, Tunnel & Turnpike Association (IBTTA) has established a goal of true nationwide interoperability by 2016. Likewise, the most recent national transportation bill signed into law in June 2012 includes a requirement that the U.S. achieve nationwide interoperability within four years of the enactment of that bill.

The current ownership structure of accounts and the use of multiple technology protocols are major impediments to achieving nationwide interoperability in the U.S. Embodiments of the invention discussed herein, in part, are intended to overcome each of these obstacles and facilitate the national objective of a single electronic toll account being accepted at toll facilities across the country.

Of all travel market segments, the trucking industry stands to gain the most from nationwide toll interoperability. Simply stated, many trucks travel nationwide; and pass between dozens of toll facilities and individual toll agencies. Many trucks are enrolled in an electronic toll program, but this program may only operate within a given region; and trucks need to stop and use cash at other toll facilities outside that region. Some trucking companies open multiple accounts at several toll agencies, but they receive individual invoicing and they need to make payments, to the same multiple agencies. These multiple agreements and corresponding multiple payments substantially increase the complexity and bookkeeping associated with toll payments by the trucking industry.

Another major issue that plagues extensive vehicular travelers is the difficulty in reconciliation between vehicle usage patterns and electronic toll invoices received from toll agencies. Typically, trucking companies may receive an invoice for toll charges a month or more after the vehicle has passed through a tolling point. This makes it very difficult to reconcile the appropriateness of toll charges, both in terms of vehicle usage records and appropriate vehicle classifications. The trucking industry would place great value on being able to operate with electronic tolls nationwide, preferably with a single account, and have a basis for online automatic reconciliation of appropriate toll charges.

Rental cars present another challenge to ETC. Since the rental vehicle is normally used by multiple different drivers over the course of a year, rental car companies have difficulty in properly allocating electronic toll charges to individual users. Further, if electronic toll collection is used, the rental car companies suffer from the same problems of delayed invoicing; where invoicing for a particular toll transaction is received, perhaps, one month after the individual rental of the vehicle has been closed out.

As such, a limited number of third party toll service providers have emerged to serve the rental car industry specifically. These providers either rent removable transponders or rely on license plate imaging by toll agencies. In either case, the third parties ultimately charge the driver for tolls incurred on a previous trip, plus a fee for service and transponder rental. The third parties also guarantee payment to the toll agencies.

The biggest problem, amongst others, with the current approaches, however, is that these methods do not provide an opportunity for toll charges to be included in the rental charge itself at the time the vehicle is returned. This causes a hardship to customers, particularly business travelers, since billings for toll collections may well be received by the car renters months following the actual rental.

A major focus of embodiments of the invention are services which will be provided to the trucking industry. As background, there are more than 11 million trucks currently registered in the U.S. Of these, almost 4 million are “Class 8” or larger, basically the typical tractor/trailer combination which often travels nationally. Many of these vehicles are equipped for electronic toll collection, but in most cases this is limited to a single agency or a single interoperable region.

Many of the larger truck fleets in the U.S. have implemented transportation management systems, some of which include sophisticated electronic “on-board units” (OBU) which monitor vehicle location, speeds, driver performance, engine idling and so forth. The most recent federal transportation authorization, referred to as MAP 21, includes new requirements for even greater use of automated OBUs on a broader proportion of trucks in the U.S. The OBUs communicate directly with a centralized transportation management system (TMS) to provide trucking company management with continual information about the position and operating condition of vehicles.

In many cases, trucking companies either develop these systems, or purchase these systems, and operate them internally. Some other TMS systems are offered by third party “hosted” TMS service providers. Information that TMS systems provide include notifications at the beginning and end of each particular truck trip, as well as a wide range of activities which occur while the vehicle is en route. The OBU devices typically include a GPS subsystem which is used to constantly identify the geo position of all vehicles in the fleet, anywhere in the world. The OBU communicates with the TMS to provide information regarding vehicle usage.

All states provide a number of weigh station locations which, when operating, trucks are required to enter. Vehicles entering the weigh station are asked to either stop, or come to a “rolling stop” to verify that the vehicle is not overweight. Some trucking companies, depending on safety records and other factors, are eligible to receive special authorization to by-pass weigh stations, subject to approval of the individual weigh station operations management. The most dominant program used is referred to as “Pre-Pass”, a not-for-profit organization which reviews and approves eligibility for the service.

Trucks enrolled in the current Pre-Pass system are provided a special transponder device, similar to an electronic toll transponder. As the vehicle approaches a weigh station, a roadside reading device reads the transponder, identifies the truck as being eligible for possible by-pass, and upon authorization from the weigh station, illuminates a signal inside the vehicle advising the driver that she need not stop. Embodiments of the present invention relates to an alternative means of notifying drivers of weigh station by-pass authorization, which does not require use of the Pre-Pass transponders or previously installed Pre-Pass transponder reading equipment.

Embodiments of the present invention may comprise any combination of the following components listed below and described in further detail in relation to example embodiments:

1. A “third party” national toll service provider, which provides electronic toll payment products, and maintain accounts, which are accepted at participating toll agencies throughout the United States, or a region.

2. A multiple transponder cluster solution (or the use of a single multiple protocol transponder) intended to overcome the differential electronic toll collection protocol problem in the U.S., in which multiple transponders are provided to participating vehicles which can be read by all types of systems in use in the U.S., and all of which are linked to a single toll account operated by a third party national toll service provider.

3. National truck toll service provider, working within the framework of the “third party” toll service provider set forth above, which specifically provides:
a) A single account for trucking industry customers which is accepted at all participating toll agencies in the United States;
b) Near “real-time” toll transaction reporting to trucking company accounting systems;
c) A unique parallel toll transaction processing approach which uses a combination of “virtual” tolling, making use of existing or new intelligent on-board units and TSM systems, along with traditional toll agency electronic tolling using the multiple transponders (as described above);
d) On-line automatic reconciliation of toll agency billings, as compared with virtual toll transaction records generated by embodiments of the invention, using input from truck company TMS systems; and
e) Customized toll transaction billing, by vehicle, driver or trip, regardless of the number of different toll facilities or toll agencies the truck may encounter on a trip.

3. “Virtual” weigh station by-pass authorization, using existing company TMS systems (including OBU geo-positioning systems), and direct communication linkages to and from weigh station subsystems for authorization. This approach works outside the current “Pre-Pass” system, without using “Pre-Pass” system equipment or transponders.

4. A rental car “virtual” parallel tolling system, which uses on-board units in rental cars for real time “virtual” tolling in conjunction with electronic toll transponders for parallel transaction processing by toll agencies.

In some of the FIGS. and throughout the specification, the following terms are used and have the following meanings
a) X-Tolls—A general term used to refer to embodiments of the overall third party electronic toll services methods, as described below;
b) T-Tolls—A general term used to refer to embodiments of the national truck tolling service provider methods, as described below; and
c) R-Tolls—A general term used to refer to embodiments of the national rental car electronic tolling system methods, as described below.

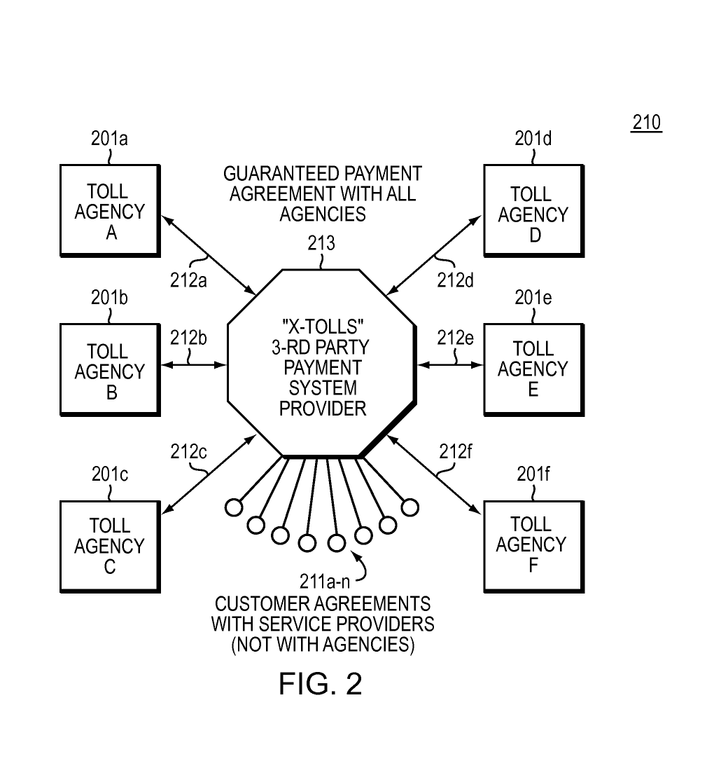

FIG. 2 is a simplified graphical depiction of a method 210 for providing third party electronic toll services, which may be referred to herein as X-Tolls. Under this arrangement, individual customers (vehicle drivers) 211a-n open electronic toll accounts directly with the third party service provider 213. This is in direct contrast to current methods, in which individuals open accounts with the toll agencies themselves. According to the method 210, the third party provider 213 issues transponders, based on the level and area of service desired by the individual customers 211a-n, up to and including nationwide tolling service. The specific number and type of transponders to be provided would depend on the number of zones of service required by the individual motorists 211a-n. The provided transponders are linked to the same customer account number, together with the vehicle license plate number that is associated with the individual customers 211a-n.

The third party provider 213 enters into agreements 212a-f with all (or most) toll agencies 201a-f throughout the United States (possibly Canada as well). While example embodiments of the present invention are described as being used within the U.S., embodiments of the present invention are not so limited and the principles of the present invention may be implemented in a number of countries, regions, and continents. The agreements 212a-f may include a guarantee payment agreement, under which the third party provider 213 guarantees payment for all toll transactions made by valid accounts managed by the third party system provider 213 and associated with the customers 211a-n.

In the method 210, the toll agencies 201a-f agree to accept the third party payment product provided by the third party provider 213, and electronically forward transaction data to a central computer system operated by the third party payment system provider 213. The third party 213 reimburses toll agencies for toll charges incurred by its member customers 211a-n, and allocates toll transactions to the appropriate individual customers. In the method 210, the customers, 211a-n may receive a tolling bill from the third party provider 213, who has the agreements 212a-f with the toll agencies 201a-f.

This service is not currently in use today in the U.S. toll industry. All electronic toll accounts are typically issued, owned and maintained by individual toll agencies, as depicted in FIG. 1. The third party toll payment service provider method 210 will satisfy industry and Congressional requirements for nationwide electronic toll interoperability, since the third party will enter into agreements with all (or most) toll agencies across the U.S.

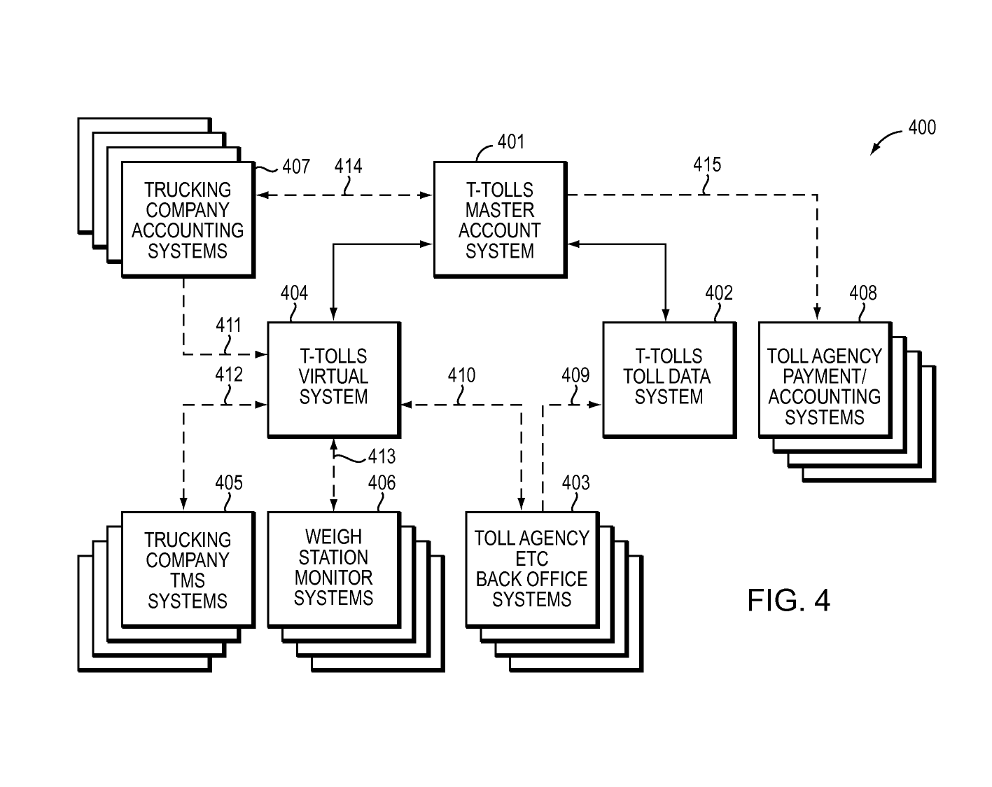

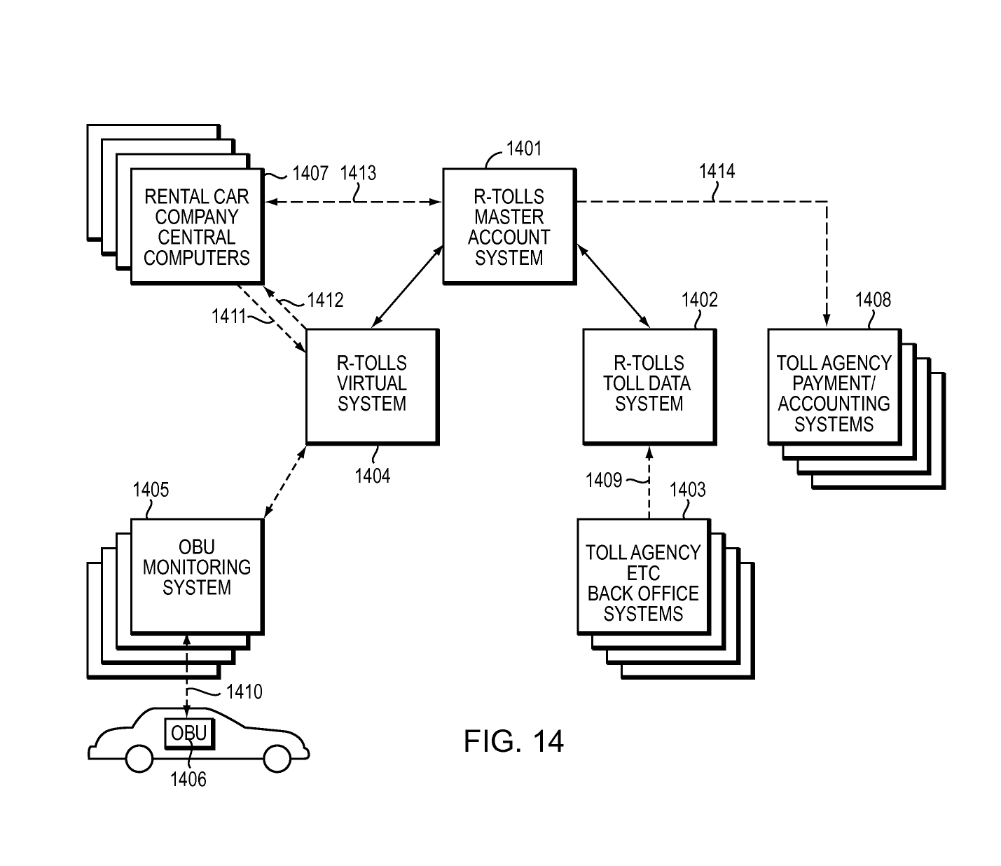

The third party toll payment service provider method 210 may be used in any embodiment of the present invention described herein. For example, both the national truck electronic tolling service described herein in relation to FIG. 4 and the national rental car electronic tolling service described herein below in relation to FIG. 14 may utilize the third party payment system provider framework 210.

There are currently seven different electronic toll collection protocols in use in the United States and Canada. Three of these remain proprietary to one supplier, while four of these now provide an open specification and may be provided by more than one vendor. A new transponder device has recently been announced which can be read by up to six of the existing protocols.

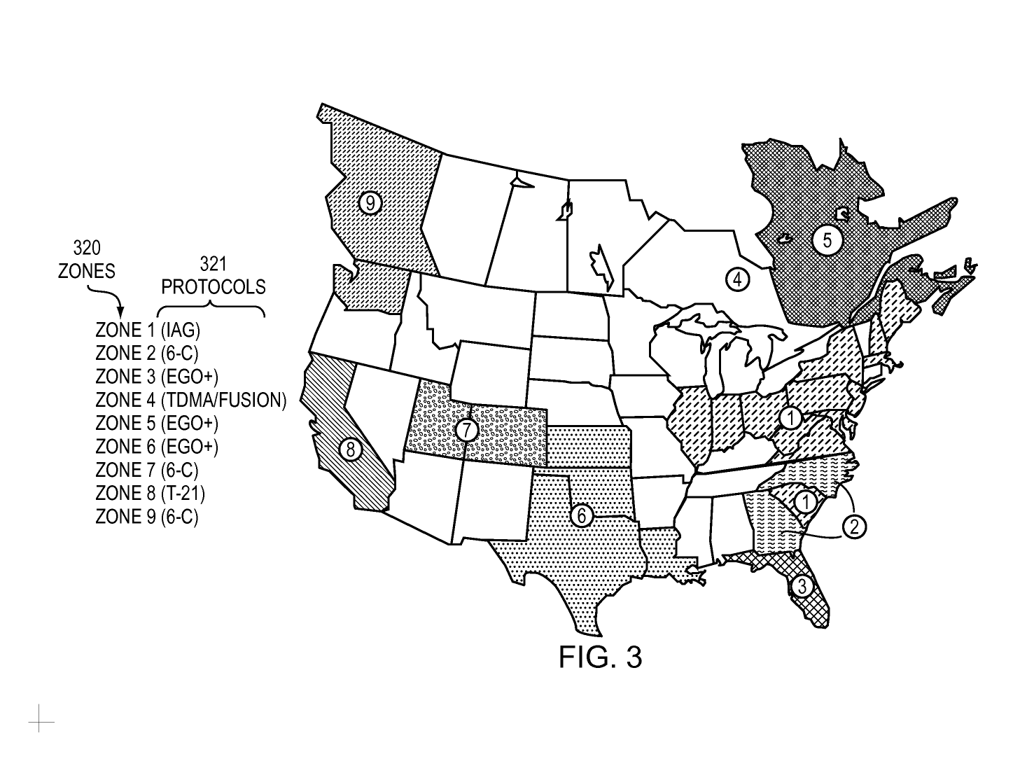

FIG. 3 shows common zones 320 and the associated electronic protocols 321 utilized in these zones 320 in the United States and Canada. Zone 1, for example, uses the IAG Protocol, developed and operated by the northeastern Inter-Agency Group, or “EZ-Pass”. There are 23 agencies included in the IAG, but all of these use the same type of technology. Hence, a single transponder is able to be read by all 23 agencies in that region. Agencies in Zone 2 currently use a transponder technology referred to as “6-C”. That same technology is used in Utah and Colorado (Zone 7), and in Washington state. In order, the provide nationwide interoperability, embodiments of the present invention must be able to utilize all of the communication protocols 321.

Optionally, in embodiments of the present invention, users may subscribe to ETC within specified zones. The common ETC zones 320 shown in FIG. 3 reflect both comparable technologies and geographic regions. These have been developed such that customers utilizing embodiments of the present invention, such as the third party truck tolling service (see below), may choose which regions they wish to have service for. In such an embodiment, a user may limit his or her service to zones 1 and 2, and thus, that user will only require a transponder that can use the IAG and 6-C protocols.

Embodiments of the present invention, use multiple transponders mounted to a vehicle windshield, but all linked to a single account, issued and maintained by the third party toll payment service provider, such as the third party provider 213. No such service exists today, and while isolated vehicles may use multiple transponders for personal reasons, today these would require separate electronic toll accounts with multiple agencies, according to the principles as shown in FIG. 1.

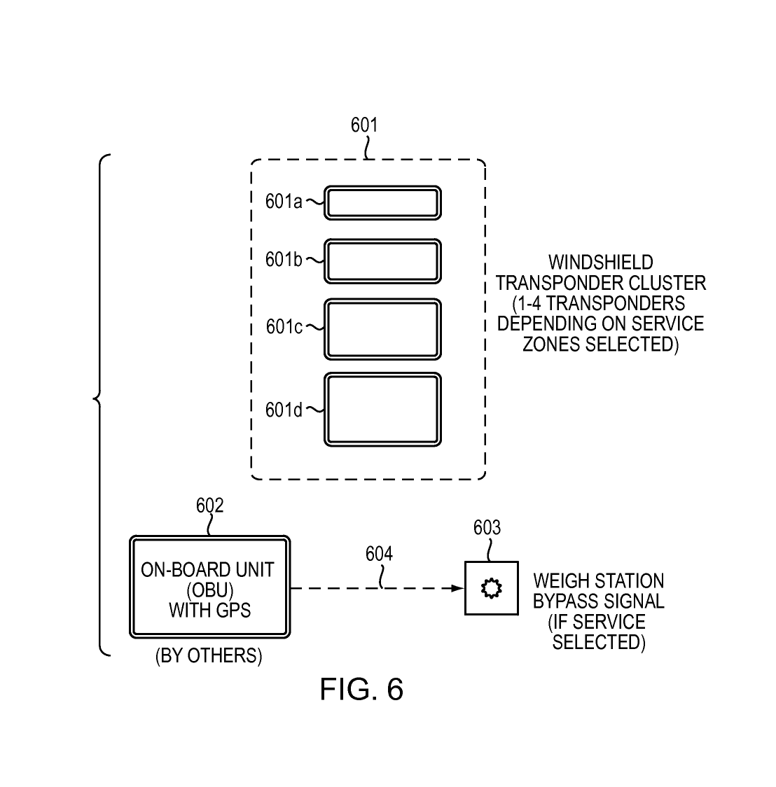

By using the multiple transponder cluster approach, within the third party electronic toll service provider approach, such as the method 210, all transponders are linked to a single common account. There is no need to open separate accounts with multiple individual agencies. The transponder cluster will enable a vehicle using the transponder cluster to be identified by any participating toll agency, regardless of technology protocol, and all transactions will be accumulated in a single account, regardless of toll agencies encountered on a trip. This is currently not available to customers in the United States or Canada. Further detail regarding the multiple transponder cluster is described herein below in relation to FIG. 6.

FIG. 4 is a simplified block diagram of a system 400 for providing tolling and other transportation services to the trucking industry. Further, the system 400 may be utilized to provide similar services to all vehicle drivers and are not limited solely to the trucking industry. Sometimes referred to herein as T-Tolls, the service 400 may be offered to trucking companies operating in the United States (and possibly Canada). An overall objective of the system 400 is to allow trucks to use electronic toll collection facilities at every participating toll agency in the U.S. and Canada (if subscribed). This will result in significant cost savings for trucking companies, and for toll collection agencies. The need for a loaded truck to stop and pay a toll, and reaccelerate, costs approximately $2.00 in fuel alone. Hence, use of this service will increase truck operating efficiency and substantially reduce fuel consumption and greenhouse gas emissions, amongst other benefits.

The service 400 will work within the third party toll service provider framework 210 described above, and will make use of the multiple transponder cluster approach, linked to a single account, also described above. It will also provide a complete parallel toll collection process, which enables online reconciliation of toll charges.

FIG. 4 depicts the overall system elements of the truck electronic tolling and weigh station by-pass authorization system 400. (Details on the weigh station by-pass system are presented subsequently). The system 400 comprises the master account system 401 which maintains accounts for all participating companies, including each of their equipped vehicles. The system 400 also includes two parallel systems for processing tolls. First, a toll data system 402 which communicates with toll agency back office systems 403 via communications channel 409 to provide electronic toll transactions from the toll agencies 403. Second, the system 400 further comprises a “virtual” tolling system 404 which interfaces with trucking company TMS systems 405 via the communications channel 412 to create “virtual” toll transactions based on information provided by the company TMS systems 405.

The master account system 401 is also be connected with the trucking company accounting systems 407 via the communication channel 414 and the toll agency payment/accounting systems 408 via the communication channel 415. Further, the trucking company accounting systems 407, may be communicatively coupled via the channel 411 to the virtual tolling system 404. In addition, the toll agencies 403 may communicate with the virtual tolling system 404 via the channel 410 to clarify discrepancies, the system of which is described in further detail herein below.

While the various systems of the tolling system 400 are shown as individual systems, various embodiments of the present invention may combine systems in any combination that may be determined by one or ordinary skill in the art. For example, the toll agency back office system 403 and toll agency accounting systems 408 are depicted as separate systems, however, in an embodiment of the system 400, the back office system 403 and toll agency accounting system 408 may be combined. Furthermore, the various systems of the tolling system 400 may be implemented via any means as is known in the art. For example, the various components of the system 400 may be implemented in a combination of hardware and software using principles known to one of ordinary skill in the art. Furthermore, the communications channels in the system 400 may be implemented using any communications means known in the art, such as a local area networks (LANs) and/or wide area networks (WANs).

In an example operation of the system 400, each time an enrolled vehicle passes through an electronic tolling point, the trucking company TMS system 405 will send a message via the channel 412 to the virtual toll system 404. The virtual toll system 404 will recognize the appropriate vehicle and vehicle account, as well as the geographic coordinates of the particular tolling point. Based on data stored in the virtual system 404, and/or a database associated with the system 404, a virtual toll transaction is created, for the individual vehicle which passes through the tolling point based on the vehicle classification (also provided by the TMS 405) and the prevailing schedule of tolls at that particular tolling point. This virtual tolling transaction may be considered geo-positional tolling, i.e., tolling that is based upon the location of the truck alone. In this example embodiment, the virtual tolling transaction is created when it is detected that the truck has gone through a geo-spatial position that is associated with a toll. To accomplish this, the TMS system 405 and/or the virtual tolling system 404 comprises data, or can access data regarding the geo-positioning of tolls.

In parallel with this virtual tolling, as the vehicle passes through the tolling point, roadside equipment provided and maintained by the toll agency 403 will read an appropriate transponder and create a traditional electronic toll transaction message, which is accumulated in the toll agency back office system 403. Periodically, toll transaction records for accounts associated with the electronic truck toll service provider 402 are transferred via the channel 409 to the toll data system 402. Under normal circumstances, therefore, two identical records of the same toll transaction exist, one created by the virtual system 404, based on information forwarded to it by the TMS 405, and one created by the toll agency 403 after reading the appropriate toll transponder. Subsequently, these two records may be compared and reconciled in the master account system 401. In this example embodiment of the system 400, toll charges are periodically communicated to the trucking company accounting systems 407 via the communication channel 414 and, after clearance, payments for toll truck electronic transactions are transferred to the toll agency accounting systems 408 via the communication channel 415 by the master account system 401. Thus, as described hereinabove, a system user is provided with both accurate and nationwide ETC.

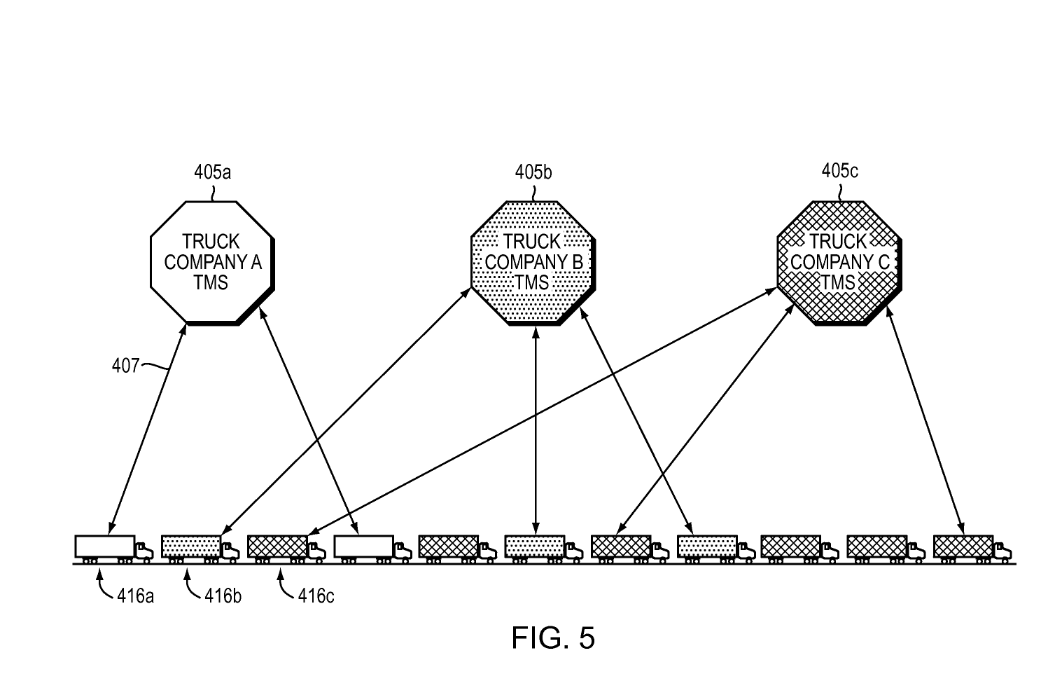

The system 400 uses existing or new trucking company TMS systems 405. FIG. 5, illustrates how the TMS systems 405a-c communicate with on-board units (OBUs) (not shown), via wireless communication channels such as 407. OBUs are installed in many of the larger trucks and embodiments of the present invention may leverage this existing technology. Optionally, such OBUs and/or TMS systems may be provide to user according to embodiments of the present invention. As noted above, a large volume of information is gathered by the OBU and communicated through the TMS systems 405a-c.

In the example system illustrated in FIG. 5, each truck, such as the trucks 416a-c, have an OBU installed thereon. The OBUs communicate with the respective TMS systems 405a-c, that each trucking company has implemented. Using the OBUs and TMS systems 405a-c, the trucking companies can have real-time data regarding their fleets.

Under the third party electronic truck tolling service plan 400, described above, certain messages received by the company TMS systems 405a-c will be forwarded to the toll service provider “virtual” system 404, including:
a) Trip start message—which will enable the virtual system to open a “virtual” trip in its database;
b) An “event” message each time the vehicle passes a tolling point; and
c) A trip end message signaling the completion of a particular shipment activity and enabling the virtual system to close out the trip.

To accommodate this, under an embodiment of the invention, the geo-coordinates of each participating tolling point in the United States and Canada are downloaded, through the company TMS systems 405, onto each OBU in each vehicle. The OBUs will then sense when the vehicle encounters a tolling point the instant the vehicle reaches the specific stored coordinates. The OBU will then generate a “virtual toll transaction” message; send this to the TMS 405, which will forward the message to the T-Tolls virtual toll system 404.

The TMS systems 405, and the associated OBUs, are already in use in thousands of trucks across the U.S. While some additional trucks may acquire OBUs and TMS systems so as to implement embodiments of the present invention, most TMS systems and the OBU already in existence may be used to implement embodiments of the present invention.

FIG. 6 shows an example equipment configuration which may be installed in a vehicle enrolled in the electronic truck toll services program 400. The transponder 601 is a windshield transponder cluster which may be a cluster of different types of electronic toll transponders 601a-d. The number of transponders in the cluster 601 varies depending on the number of regions and the respective tolling communication protocols in the region that a user subscribes to. For example, the number of transponders may vary from 1-4 transponders depending on the number of service zones selected by the trucking company. If only a single zone of service is required, then only one transponder will be provided; if full national U.S. and Canadian service is desired, up to four transponders may be required. Further, the number of transponder may vary depending on the communication protocols, embodiments of the present invention may use a transponder cluster 601 that comprises any number of transponder that are necessary to provide the desired level of interoperability. It may also be possible to provide capability for multiple protocol reading through the use of one or more multi-protocol transponders. In either case, all transponders (or multi-protocol transponders) would be linked to the same third party issued account, and the vehicle operator would not be required to have separate accounts.

In an embodiment of the present invention, all of the transponders 601a-d of the transponder cluster 601 are linked to a single electronic toll collection account, operated by the national electronic truck toll service provider, 401. The transponder cluster 601 may be mounted on the inside of the windshield of a truck, or the tractor portion of a combination vehicle. The transponder cluster 601 may be permanently mounted and will not be required to be removed between individual trips. Some transponders 601a-d that make up the transponder cluster 601 take the form of small decal stickers, while others are hard case plastic devices. It is not anticipated that, in any case, more than two hard case transponders will be required, and the four transponder cluster will be structured so as to not impair full visibility in the windshield.

In addition to using a transponder cluster 601, embodiments of the present invention may also utilize an OBU 602. The OBU 602 may comprise an internal GPS device to continually track the exact vehicle location. Embodiments of the present invention may utilize information which is emitted from the OBU to the TMS system. While, the OBU 602 provides multiple different types of data, embodiments of the present invention may only require a subset of the data provided by the OBU 602. For example, embodiments of the present invention may only require specific tolling point location geo-coordinate information (as well as weigh station location information) from the OBU 602 in a vehicle.

While described in further detail herein below, the OBU 602 may also provide a weigh station by-pass signal 603, in an embodiment of the present invention that provides weigh station by-pass capability. If weigh station by-pass service is selected a small illuminated signal 603 will also be provided within the vehicle. This will be illuminated based on communication 604 from the OBU when by-pass authorization is received. While the by-pass signal 603 is described as an illuminated signal, a weigh station by-pass indication may be provided by any means known in the art. For example, an audible prompt may be used to indicate that weigh station by-pass is allowed.

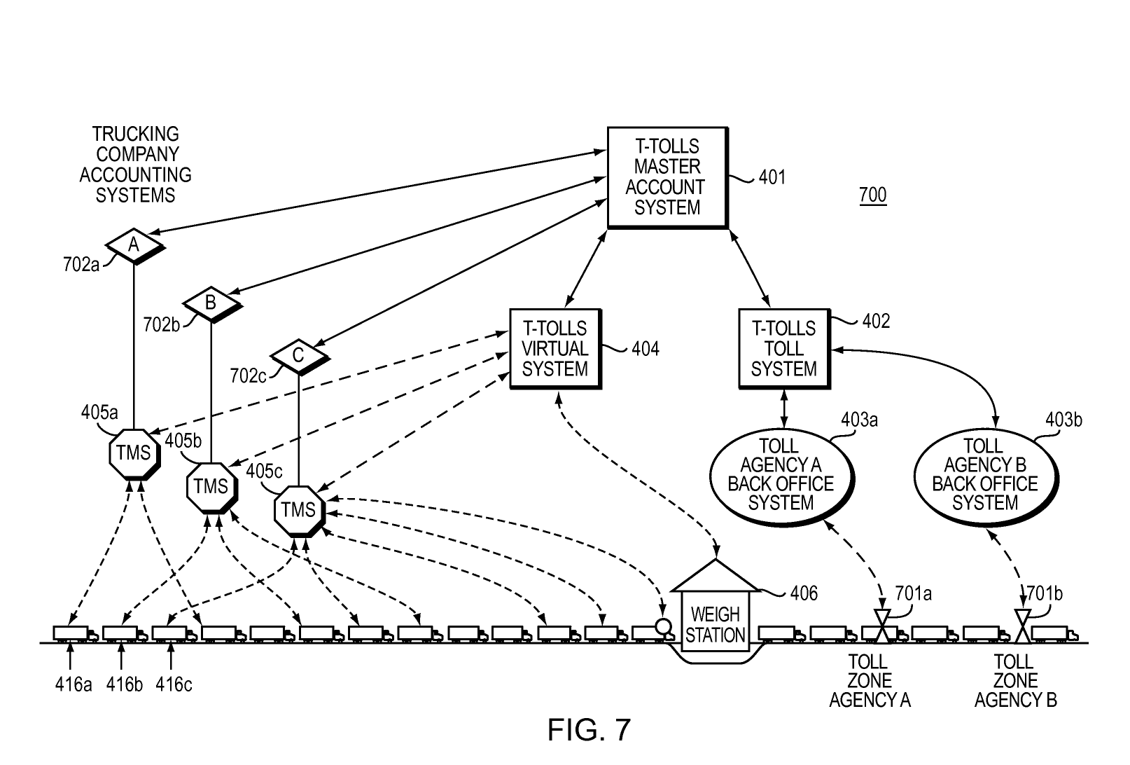

FIG. 7 illustrates an overall system diagram for an integrated truck toll payment and weigh station by-pass system 700. The system 700 comprises the individual trucks, such as the trucks 416a-c, that may be associated with one or more trucking companies. The trucks with OBUs (not shown), are communicatively coupled to the TMS systems 405a-c. As described herein the TMS systems 405a-c are communicatively coupled to the virtual tolling system 404 which provides geo-position based tolling. Further, the TMS systems 405a-c may be in communication with the trucking company accounting systems 702a-c. The system 700 further comprises the tolls 701a and 701b, that are coupled to the respective tolling agency back offices 403a and 403b. The tolling agency back offices 403a and 403b are in turn communicatively coupled to the tolling system 402, which provides transponder based tolling. The virtual tolling system 404 and the transponder based tolling system 402 are both communicatively coupled to the master system 401.

The master account system 401, toll system 402, and virtual system 404 may function as described hereinabove in relation to FIG. 4. In the system 700 the TMS systems 405a-c communicate with trucks, such as the trucks 416a-c when the trucks are en route. The TMS systems 405a-c also communicate with existing trucking company accounting systems 702 that are also connected to the master account system 401. In this manner, the OBUs for the trucks will provide the TMS systems 405a-c with their position, amongst other data, and this information can be communicated to the virtual tolling system 404 to provide for virtual tolling as described hereinabove.

To provide weigh station by-pass functionality, the OBUs will communicate with the TMS systems 405a-c, to provide positioning information, this information will in turn be communicated to the virtual tolling system 404. The virtual tolling system 404 can then communicate with a weigh station, such as the weigh station 406, to request weigh station by-pass. The weigh station 406 can then communicate its acceptance or denial, which can in turn be communicated to the truck via the virtual tolling system 404, and respective TMS system.

FIG. 7 also illustrates a representation of electronic tolling points 701a and 701b for the tolling Agencies “A” and “B”. The electronic tolling points 701a and 701b gather information by reading electronic toll transponders and store that information in the agency's back office systems 403. As described herein, this data may be sent to the T-Tolls toll system 402 for later comparison with the virtual toll transactions created by the virtual tolling system 404 for reconciliation purposes. In the system 700 the trucks, such as the trucks 416a-c are equipped with transponders that can be read by all toll agencies, such as the toll agencies 701a-b. Thus, the trucks are provided with transponder based tolling interoperability.

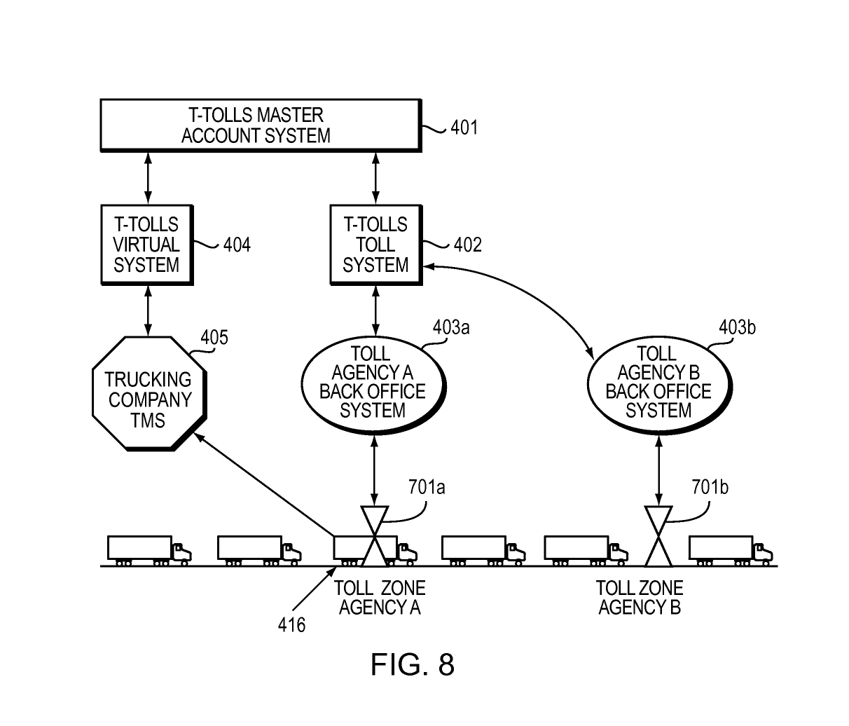

FIG. 8 depicts the two forms of parallel truck tolling. The functionality of the two forms of truck tolling will be illustrated in the following example implementation that is described herein below. In the system, as the enrolled truck 416 passes through a tolling point 701a, a GPS portion of an OBU recognizes that the tolling point 701a has been encountered based on the geo-fencing coordinates loaded into the OBU's memory. This triggers an event message from the OBU to the trucking company TMS system 405. The TMS system 405 relays the message to the virtual tolling system 404. In response, the virtual tolling system 404 creates a virtual toll transaction message that includes the date, time and vehicle identification, together with the particular tolling point, toll agency and toll amount. The toll amount will be based on data stored in the virtual tolling system 404, and/or a database associated therewith. In an alternative embodiment, the tolling rate information may be determined by the OBU and/or the TMS 405. Further, the tolling amount data may be regularly updated by toll agencies and this data may be communicated to the virtual system 404, TMS system 405, and/or OBU. If variable toll charge structures are in place, the appropriate toll charge is based on the time of day of the toll transaction. The vehicle classification in the virtual system may be based on information provided by the TMS 405 at the time the trip is started.

In parallel to the above activity for virtual tolling, the toll agency equipment at the tolling point 701 reads the appropriate electronic toll transponder on the enrolled truck windshield 416. This will enable the system to generate an electronic toll transaction. In this embodiment of the present invention, when the transponder is read at the tolling point 701a, this is communicated to the tolling agency back office 403a, and the tolling agency back office 403a communicates the transponder tolling event to the transponder tolling system 402. In most cases, automatic classification equipment operated by the toll agency will classify the truck vehicle and the classification will be included on the electronic toll transaction message. At pre-determined intervals, the toll transactions may be transferred to the T-Tolls toll system 402, and eventually compared with the virtual toll transaction in the master account system 401 for on-line reconciliation. As described herein, the master account system 401, may then communicate with the trucking company and the tolling authorities regarding payment and any asserted discrepancies.

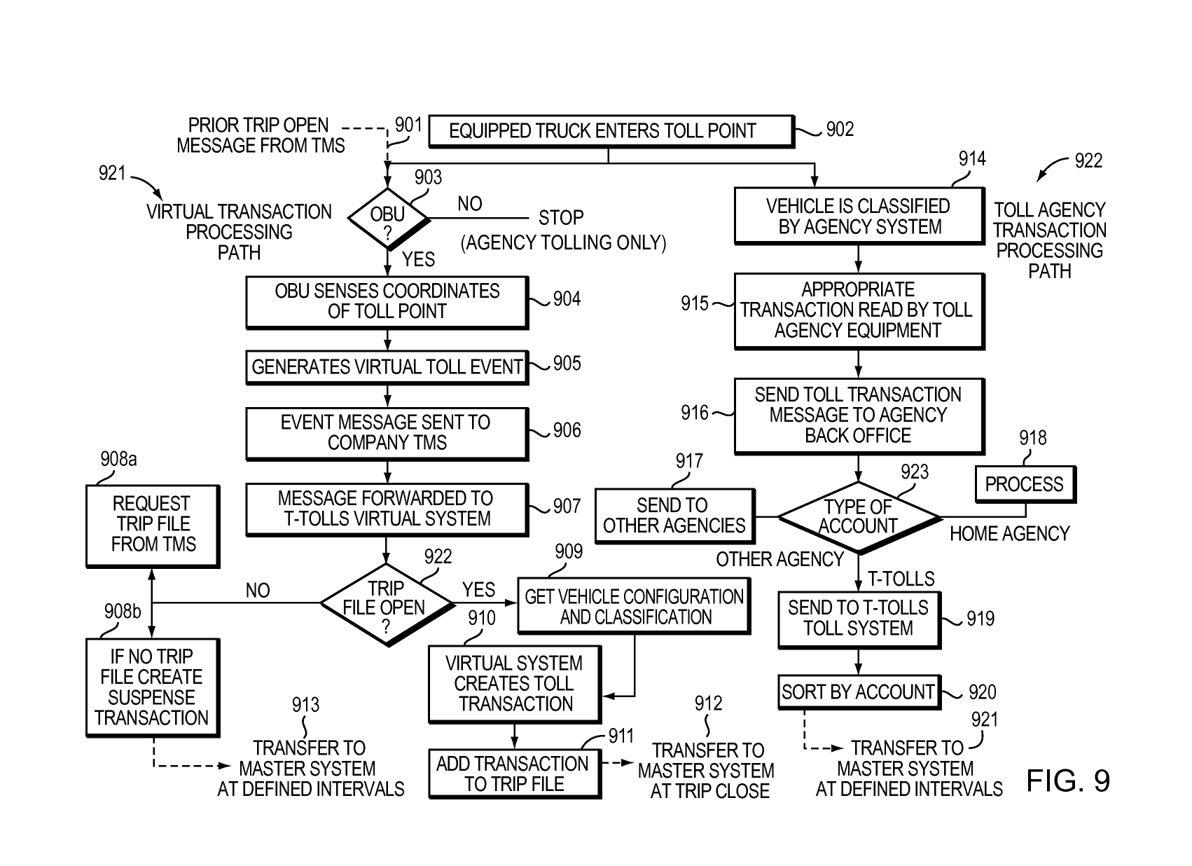

FIG. 9 illustrates a typical toll processing flow diagram according to an embodiment of the present invention. This particular diagram assumes that the virtual system, previously received a trip open message from the TMS for the particular truck in question (901). As the truck enters the tolling point 902 the parallel processes 921 for virtual tolling and 922 for transponder tolling begin.

In the process 921 for virtual tolling it is first determined at step 903 if the truck has an OBU. If the truck does not have an OBU, the process 921 stops. However, the transaction may still be processed by the toll agency according to the process (922). If the truck has an OBU, the OBU senses the geo-spatial coordinates of the tolling point (904). In response, the OBU generates a virtual toll event message, 905, and the tolling event message is sent to the company TMS (906). Next, this tolling event message is relayed from the TMS to the virtual, i.e., geo-positional tolling system (907). Embodiments of the present invention may utilize trip files, thus creating a record on a trip by trip basis. In the embodiment of the method depicted in FIG. 9, if it is determined at step 922 that a trip file is already open, the virtual tolling system will get vehicle configuration and classification information at step 909 and create a virtual toll transaction (910). This virtual toll transaction created at step 910 is then added to the transaction trip file (911). At step 911, the system may pause and wait for further possible tolling events, and then upon trip end communicate the trip information to the master system at step 912. However, in an alternative embodiment, the trip information may be communicated to the master system in real-time or at determined intervals. If it is determined at step 922 that the trip file record has not yet been received for the particular vehicle, the system will request a trip open file from the TMS (908a). If however, no trip file is created a virtual tolling transaction is created that is not associated with a particular trip 908b and still communicated to the master system at step 913. Upon completion of the virtual tolling process 921, the virtual tolling information generated using geo-positioning is communicated to the master system.

While the virtual tolling process 921 is being carried, the toll agency transaction path 922 is also being performed. The toll agency transaction processing path 922 may be carried out according to the principles of transponder based tolling described herein. In the transponder tolling process 922, after a truck enters the toll point at step 902, the vehicle is next classified by the agency system (914). The vehicle may by classified by an automatic system used by the agency at step 914 and then an appropriate transaction is read by the toll agency equipment, 915, using the determined classification. A toll transaction message is then sent to the agency back office (916). After sending the tolling message to the back office, 916, transactions are sorted depending on the type of account associated with the transaction at step 923. If the transaction if associated with an account that the agency has an interoperability agreement with, the tolling transaction is sent to that agency (917). If the transaction is associated with the agency itself, it continues to process the transaction. If however, the transaction is associated with the third party electronic truck service provider, the transaction is sent to the T-Tolls toll system (919). After the tolling transactions are sent to the T-Tolls system, 919, they may be sorted by account at step 920, and sent to the master system at step 921. In another embodiment of the present invention, the transactions may be sent prior to sorting and may be sorted once received by the master system.

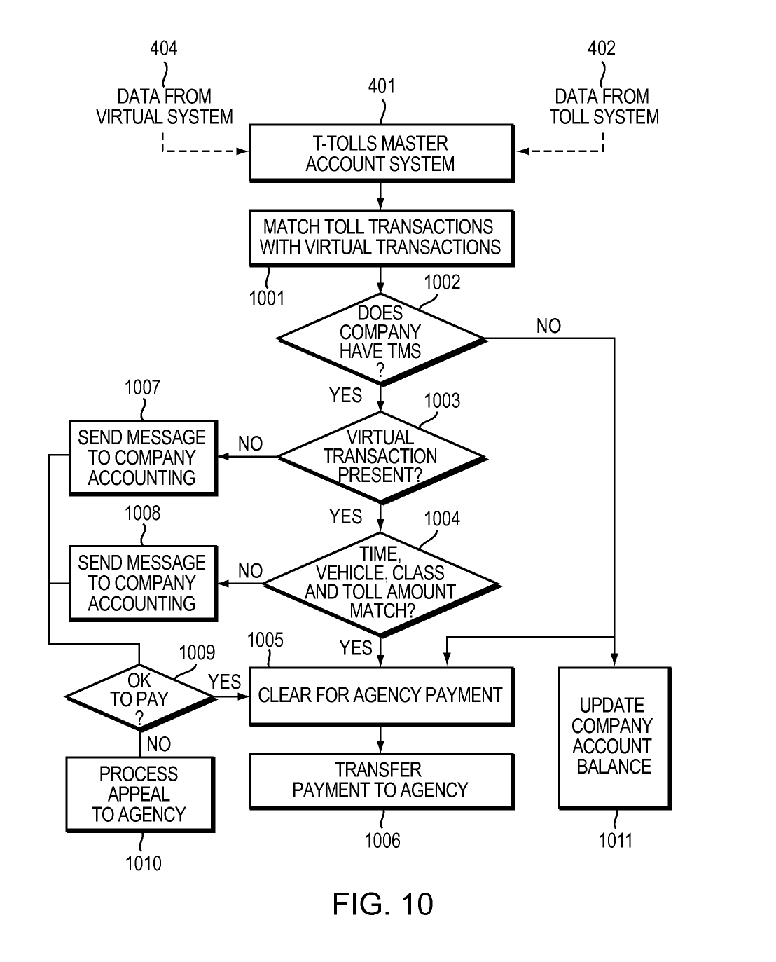

FIG. 10 illustrates a flow diagram according to an embodiment of the present invention to reconcile transactions and process payments. In such an embodiment, data is periodically received from the virtual system 404 and the toll system 402 into the master account system 401. As information is received from the toll system 402, which typically lags the arrival of data from the virtual system 405, toll transactions are matched with the virtual transactions at step 1001 for reconciliation purposes. Next, it is determined if the company, for which transactions are being processed has a TMS system (1002). If the company does not have a TMS system, the companies account balance is updated at step 1011 to reflect the toll transaction. Once the company account has been balanced 1011, the next step is to ensure the transaction is clear for payment to the tolling agency, 1005. Once, a payment has been cleared, 1005, payment is sent to the tolling agency (1006).

If it is determined at step 1002, that the company has a TMS system, the master account system checks to see if a virtual transaction is also present, that matches a toll agency transaction (1003). If there is no virtual transaction present, the system sends a message to the trucking company accounting system indicating that an agency transaction has been received for which there is no matching “virtual” transaction (1007). If the virtual transaction is present, then the time, vehicle class and toll amount will be compared with the toll agency transaction at step 1004. If the data for the virtual tolling and agency tolling do not match, the system will automatically send a message to the trucking company accounting system indicating such (1008). If there is a match, the transaction is cleared for agency payment 1005, and when cleared for agency payment, the payment is sent to the tolling agency (1006). When a discrepancy is found and communicated to the trucking company accounting, the trucking company then decides if it is ok to pay (1009). When the trucking company decides it is ok to pay, the payment is cleared for agency payment, 1005, and then payment is sent to the agency 1006. If however, the trucking company decides that it is not okay to pay, the trucking company proceeds to appeal to the agency 1010.

The same OBUs and TMS systems previously described and utilized in embodiments of the present invention may also enable, if subscribed to by the trucking company, remote virtual authorization to by-pass weigh stations. This service will only be available to companies and vehicles which are eligible for the service, based on safety records and other considerations. To implement such an embodiment, the geo-coordinates of a point located a pre-defined distance in advance of each weigh station, and the location of the weigh station will be downloaded to the OBU of the truck. Further, in another example embodiment, this data may be maintained at the TMS system associated with truck, and the TMS system may monitor the location of the truck.

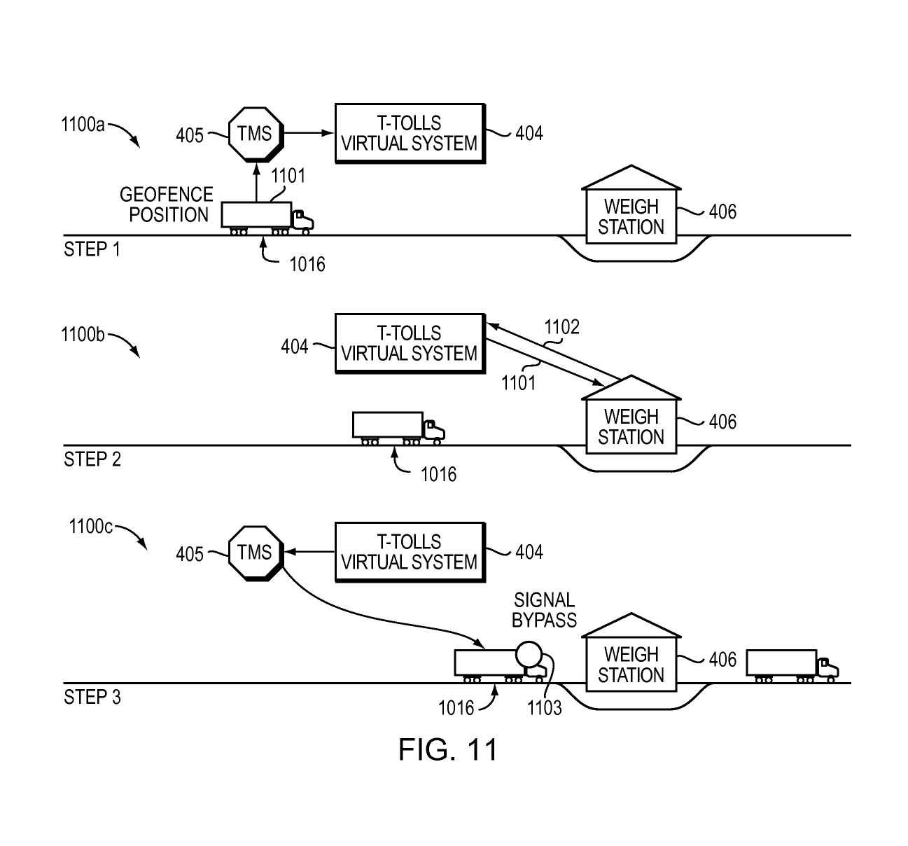

FIG. 11 illustrates the various steps 1100a-c of performing weigh station by-pass according to an embodiment of the present invention. As shown in FIG. 11, as the truck 1016, with an OBU with GPS senses that the vehicle reached the coordinates at a point in advance of the weigh station 406, a “weigh station by-pass request” message 1101 is generated and sent to the trucking company TMS 405. This message is then relayed from the TMS 405 to the T-Tolls virtual system 404 at step 1100a. In step 1100b, as the truck continues to approach the weigh station, the virtual system 404 communicates with the weigh station 406 to send the message 1101 indicating an authorized vehicle is approaching and seeking approval for the vehicle to by-pass. The weigh station subsystem 406 then responds with the message 1102 providing or denying authorization. In step 1100c, the virtual system 404, after receiving authorization from the weigh station 406, relays this information from the appropriate trucking TMS system 405 which will immediately convey the information to the OBU in the truck 1016. The OBU, in turn, will activate the signal in the vehicle 1103 indicating to the driver that weigh station by-pass has been authorized. The signal 1103 may be any signal known in to art that can be communicated to the driver. For example, it may be an indicator light and/or audible tone, amongst other indicators.

This approach allows weigh station by-pass authorization to individual vehicles without using a separate on-board transponder or roadside readers currently operated under the “Pre-Pass” system.

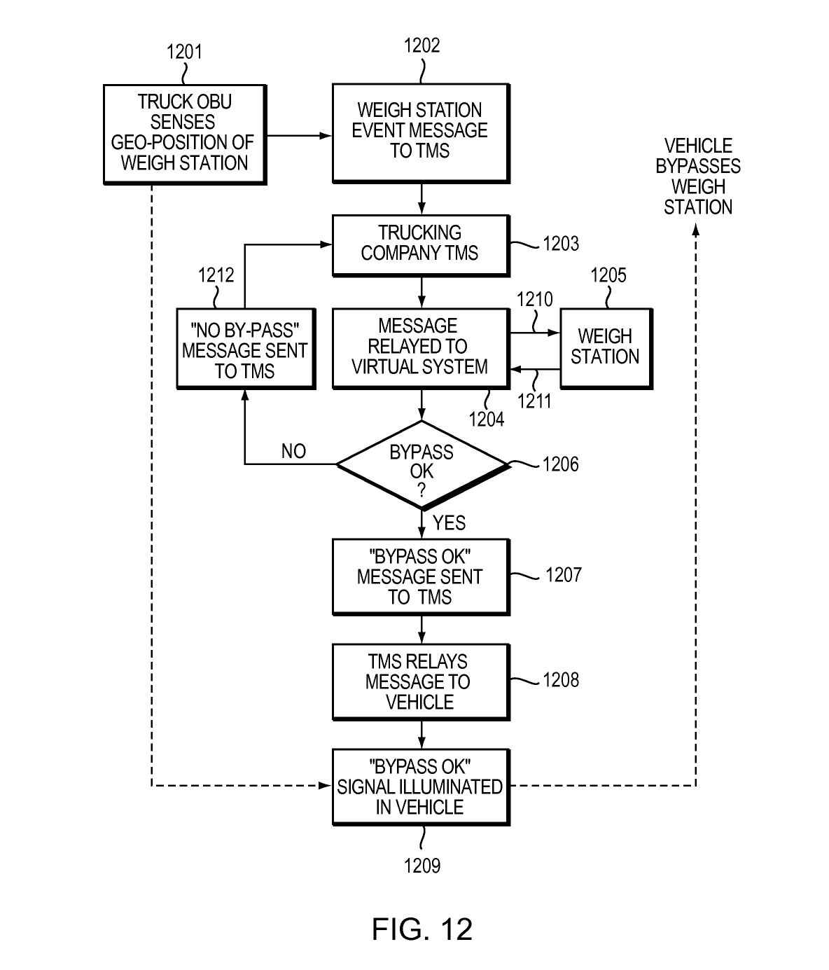

FIG. 12 is a flow diagram of a method of performing “virtual” weigh station by-pass according to the principles of the present invention. In such an embodiment, as the truck OBU senses the geo-position of the upcoming weigh station 1201, a weigh station event message is created at step 1202 and sent to the TMS at step 1203, which forwards the message to the virtual system (1204). The virtual system at step 1204 then has communications 1210 and 1211 with the weigh station (1205). At step 1206, if the weigh station 1205 does not authorize by-pass, a “no by-pass” message 1212 is sent to the appropriate company TMS 1203 indicating that by-pass is not authorized. If by-pass is authorized, a “by-pass okay” message is sent to the appropriate company TMS 1207, which then relays the “by-pass okay” message the vehicle in question (1208). When the vehicle is question receives the “by-pass okay” message, a signal is illuminated, 1209, and the vehicle by-passes the weigh station.

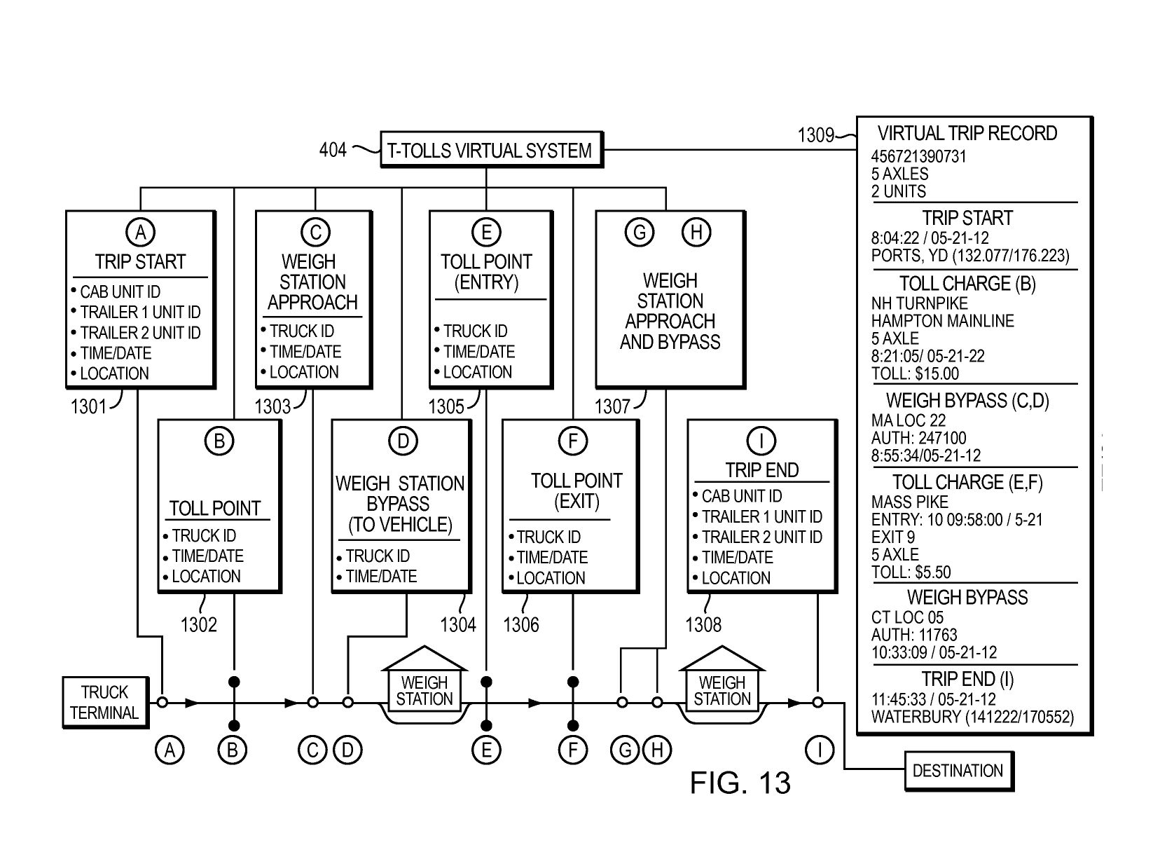

FIG. 13 shows an illustrative, hypothetical example of a truck “virtual trip record” that may be generated utilizing embodiments of the invention described herein. In an embodiment of the invention, the trip record 1309 is maintained by the virtual tolling system 404 and includes data from a TMS associated with the truck. In an alternative embodiment the trip record 1309 may be maintained by a TMS system and/or OBU. The trip record 1309 is opened 1301 when the truck leaves the truck terminal and the OBU sends a trip start message to the TMS. This message carries identification information about the tractor, trailers, account numbers, time/date, location and other information. Further, the opening message may comprise any other trip and/or vehicle information as is known in the art. When the trip start 1301 is received, the virtual system opens a “virtual trip record” 1309 for that particular truck. As the truck passes through tolling points and/or weigh stations, various other event messages, such as the messages 1302-1307, are sent to and from the vehicle, and added to the virtual trip record 1309.

When the vehicle reaches its destination, the TMS sends a “trip end” message 1308. This signifies that the virtual system 404 should close the trip and the entire trip record 1309, including all event activity, is sent to the master account system for later comparison and reconciliation performed as described herein. An electronic summary of activity on the entire trip 1309 is then sent to the appropriate trucking company accounting systems for possible use in immediate billing, if desired, by the trucking company, well in advance of when the transponder based electronic toll transactions are received from the toll agency.

Sometimes referred to herein as R-Tolls, this service which is not currently available to rental car companies or rental car customers, involves equipping rental cars with transponder clusters and on-board units to enable “real-time” electronic tolling, for inclusion of toll charges in rental car totals at the time of vehicle return. This is a significant change in the way various companies and third party entities handle tolling for rental car patrons. The R-Tolls system utilizes the principles of the invention described herein in relation to trucking industry, to provide virtual and transponder based tolling to rental cars.

FIG. 14 illustrates the system configuration for the national rental car virtual tolling system according to an embodiment of the present invention. The system may utilize the basic framework of the “third party toll payment services provider”, as described hereinabove in relation to FIG. 2. The guaranteed payment agreements reached with various toll agencies, and similar multi-transponder clusters, may be used to achieve nationwide interoperability of the rental car electronic toll payment system.

The rental car tolling system in FIG. 14 comprises a rental car program master account system 1401 and a virtual tolling system 1404 and toll data system 1402. The toll data system 1402 may be linked directly with the truck toll data system, or be a common element. The communications channels, and guaranteed payment agreements with individual toll agencies across the United States will be the same as established for the truck tolling program. The master account system 1401, will also be communicatively coupled to the rental car company computer system 1407 via communications channel 1413. Similarly, the master system 1401 will be coupled to the toll agency payment and accounting systems 1408 via the communications channel 1414. While, the rental industry virtual system 1404, toll data system 1402, and master system 1401 are described only in relation to the rental system, these may be the same systems utilized to carry out embodiments of the invention described herein in relation to the trucking industry. Further, these systems may be utilized to carry out tolling interoperability for individual car owners as well.

A unique characteristic of the rental car virtual tolling system is the implementation of a GPS-based OBU device 1406, in each rental vehicle. Embodiments of the invention also utilize vehicle tracking systems 1405, similar in concept to the TMS systems used to monitor truck patterns. Unlike the truck system, however, the new OBU monitoring systems 1406 will be operated primarily for virtual electronic tolling by rental customers, and not primarily for use in reconciling tolling.

According to an embodiment of the present invention, the on-board unit 1406 communicates via the communications channel 1410 with the OBU monitoring system 1405. In response to these communications, the OBU 1406 generates event messages based upon geo-position coordination downloaded into the OBU 1406 when the rental car passes through a tolling point. The monitoring system 1405 then communicates the toll event to the “virtual” tolling system 1404, which generates a virtual toll transaction, similar to the method used for the truck tolling program described hereinabove.

The virtual tolling system 1404 may also be directly connected to the rental car company central computer 1407, allowing for the communications 1411 and 1412 which will apprise the rental car companies of virtual tolling as it occurs. These central computers 1407 will send a message to the virtual system 1404 each time a new rental of a particular vehicle begins. The rental car company computers 1407 will also send a message when the vehicle is returned, requesting any toll transaction data from the virtual system 1404. In this way, the virtual system 1404 can track car usage and communicate tolling events to the rental car company in a timely fashion.

The rental car company tolling system further comprises the systems 1402 and 1403 for transponder tolling, similar to other embodiments described herein. The rental car tolling system may rely upon virtual, i.e., geo-positional based tolling for billing customers. A problem in current car rentals is the delay in receiving transponder based tolling information. Embodiments of the present invention utilize the geo-positional tolling data to ensure that car renters are charged for tolling charges immediately. However, in order to provide this tolling, embodiments of the rental tolling system still utilize transponder based tolling so as to comply with traditional ETC.

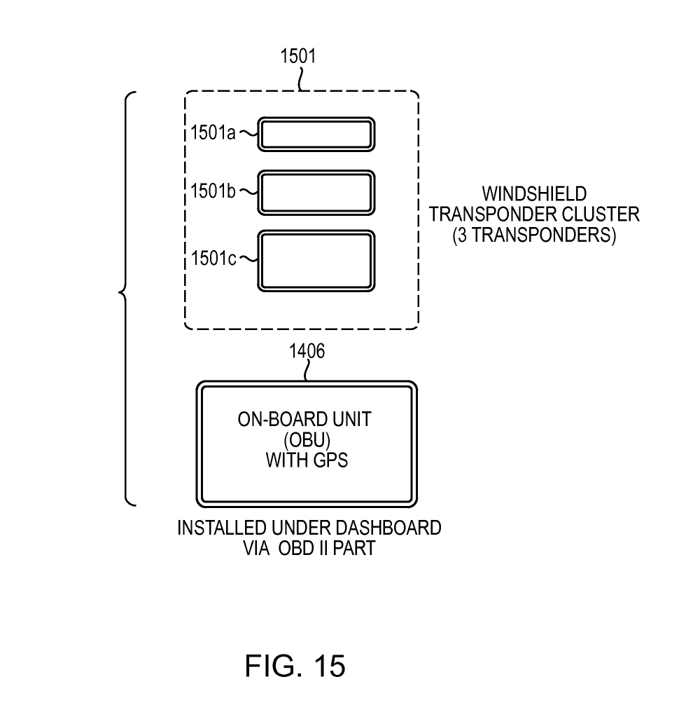

FIG. 15 shows a rental car on-board equipment configuration that may be used in embodiments of the present invention. The typical rental car on-board equipment comprises a windshield transponder cluster 1501 that includes the number of transponders, such as the transponders 1501a-c, needed to provide tolling interoperability. One or more multi-protocol transponders may also be used as an alternative for interoperability. In an example embodiment of the transponder cluster 1501, the transponder cluster 1501 comprises three transponders, including one hard case fusion transponder covering multiple protocols, and two small “sticker” transponder devices. According to an embodiment of the present invention, the transponder cluster 1501 will be permanently affixed inside each rental car windshield, in a manner so as to not interfere with clear driver vision. The devices will not be intended to be removed by individual vehicle renters, nor would they be rented to individual drivers for individual vehicle rentals, as is the current practice.

The rental car on-board equipment further comprises the OBU 1406, that will be installed under the vehicle dashboard, connected to the vehicle OBD II port. This is a diagnostic data port which has been standard equipment on all vehicles sold in the U.S. since 1996. The OBU 1406 will be loaded with the geo-fence coordinates of all tolling points in the United States and Canada. The device 1406 may continually sense the position of the vehicle during a rental and will generate event messages each time a vehicle reaches the coordinates of a particular toll zone. The OBU device 1406 may also be able to provide additional services, and according to an embodiment of the invention, be capable of two-way communication with the OBU monitoring system, such as the system 1405.

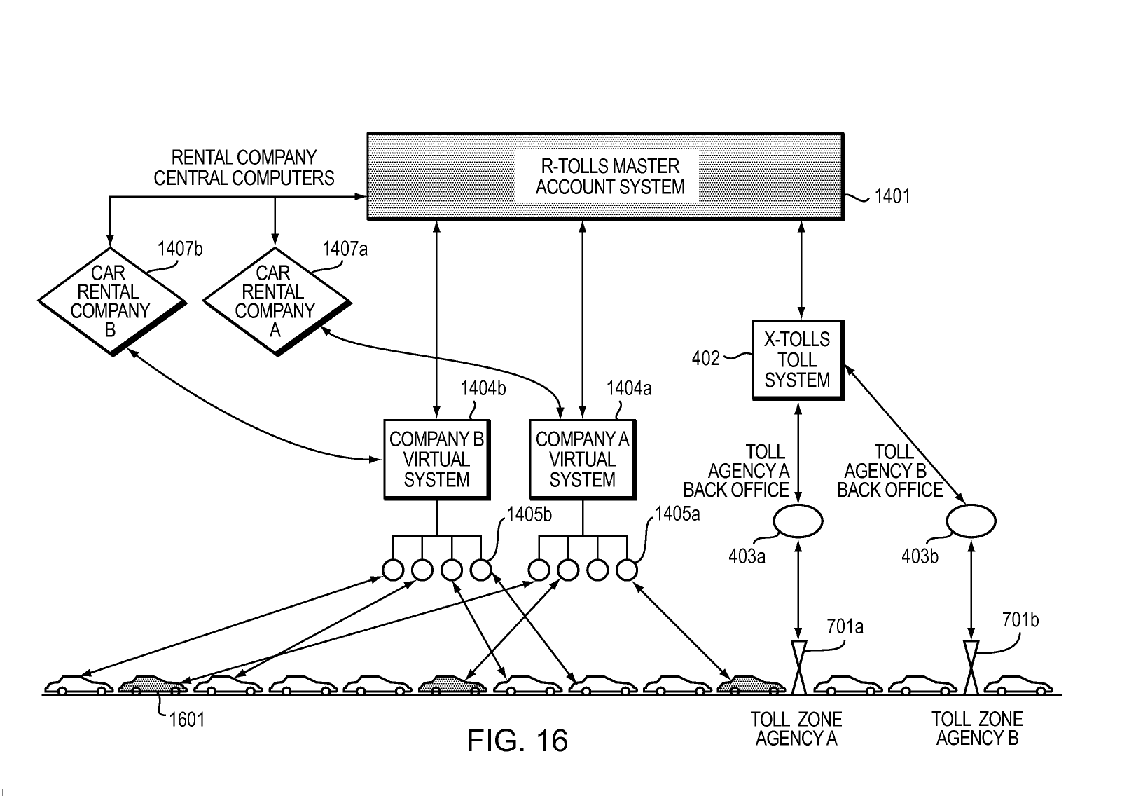

FIG. 16 provides a functional overview of the rental vehicle virtual toll system according to an embodiment of the present invention. The right portion of the diagram, which includes the transponder tolling system 402, toll agency back offices 403a and 403b and toll zones 701a and 701b, may function in the same manner of the transponder tolling systems described above. Thus, a car with a multi-agency compatible transponder passes a tolling point, such as the tolling point 701a, equipment at the tolling point 701a communicates this tolling event to the tolling agencies back office 403a, and this data is in turn communicated to the transponder tolling system 402 and master account system 1401. Further, embodiments of the present invention may utilize the same components and communication linkages which were set forth above for the truck electronic toll system to carry out the rental car tolling system.

The rental car tolling system further comprises the company virtual systems 1404b and 1404a, which may function in a manner similar to the TMS systems described herein. Further, while separate virtual systems 1404b and 1404a are depicted for each rental company, in an alternative embodiment, only one virtual system is utilized and data is for each rental car company is kept appropriately segregated. The rental company virtual systems 1404b and 1404a communicate directly with the rental car company central computer systems 1407a and 1407b, to communicate tolling and trip information to the rental car companies. The OBU monitoring devices 1405b and 1405a coupled to the virtual systems 1404b and 1404a, will continually communicate with the individual rental vehicle OBUs (not shown) so that geo-positional tolling data can be determined.

In an example implementation of the rental car tolling system, a message from an OBU, is received by the OBU monitoring device 1405b, and communicated to the virtual system 1404b. The virtual tolling system 1404b then communicates this tolling event to the rental car company computer 1407b and the master account system 1401. At the same time, transponder tolling is occurring as described herein, however there is typically a delay in receiving this transponder tolling data at the master account system 1401. Thus, in the rental car scenario, the rental car company may charge a car renter based upon the virtual tolling. Furthermore, the rental car company may also ensure that the virtual tolling and transponder tolling agree and dispute any discrepancies. Reconciling these discrepancies may comprise sending a notification to a car renter and/or the tolling agency.

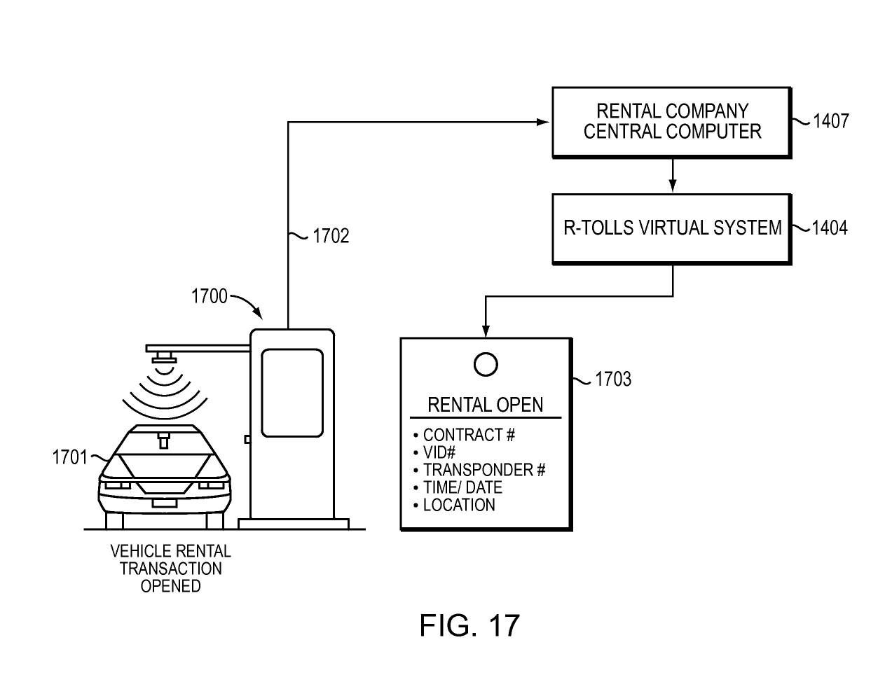

FIGS. 17, 18, and 19 depict rental transaction activity according to an embodiment of the invention. FIG. 17 illustrates the process at the time of car rental. At the time of car rental, the rental vehicle 1701 is typically at the agency rental booth and the rental contract is initiated. At the time of rental a message 1702 is sent to the rental car company central computer 1407 to open the rental account within the rental company. This will then cause the rental car company central computer 1407 to send a message to the R-Tolls virtual system 1404 indicating the vehicle rental has begun and the message will include information such as the contract number, vehicle identification number and transponder number. This process may occur automatically as the rental car 1701 exits the rental agency. For example, a transponder may be read by the reader device 1700 as the car 1701 is exiting and the transponder reader 1700 may then communicate the message 1702 to the rental car company central computer 1407. As the vehicle exits the rental car location, a “rental open” file 1703 has been established in the virtual system.

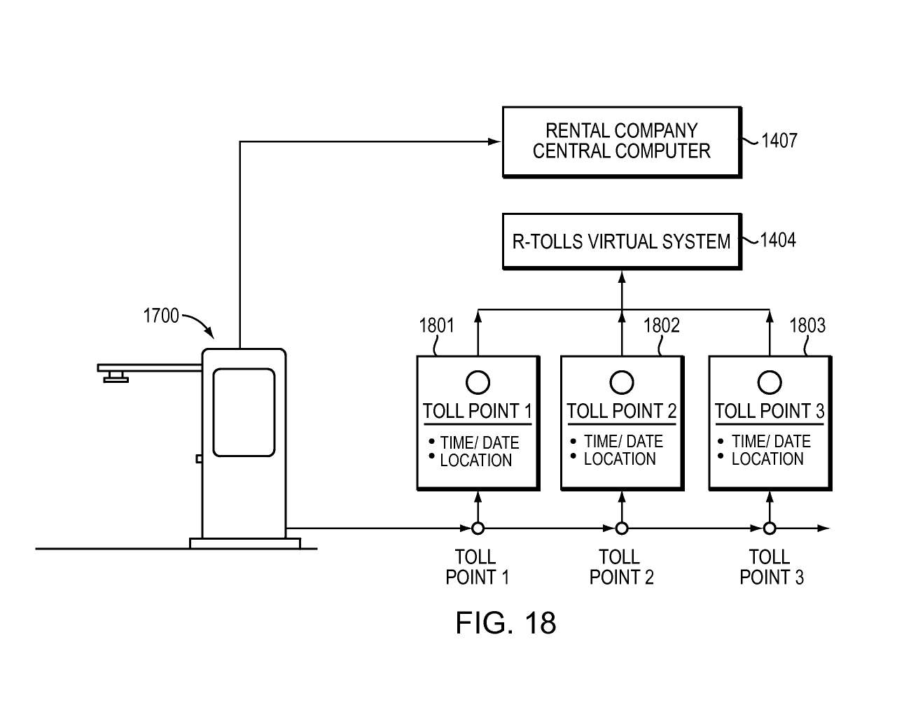

FIG. 18 depicts three hypothetical toll transactions generated during the vehicle rental. In this example embodiment, while the rental car 1701 is being used the tolling events 1801, 1802, and 1803 occur. In each case, the OBU generates an event message, which is sent to the virtual system 1404. Based upon the vehicle identification characteristics and transponder account numbers, the toll transactions are assigned to the appropriate rental contract, which was previously opened in the R-Tolls virtual system. While not shown, the tolling events may also be detected via traditional transponder based tolling, and eventually communicated to the rental car company. In an embodiment of the invention, the tolling transactions 1801, 1802, and 1803, are communicated in real time, or near real time to the rental car company computer 1407.

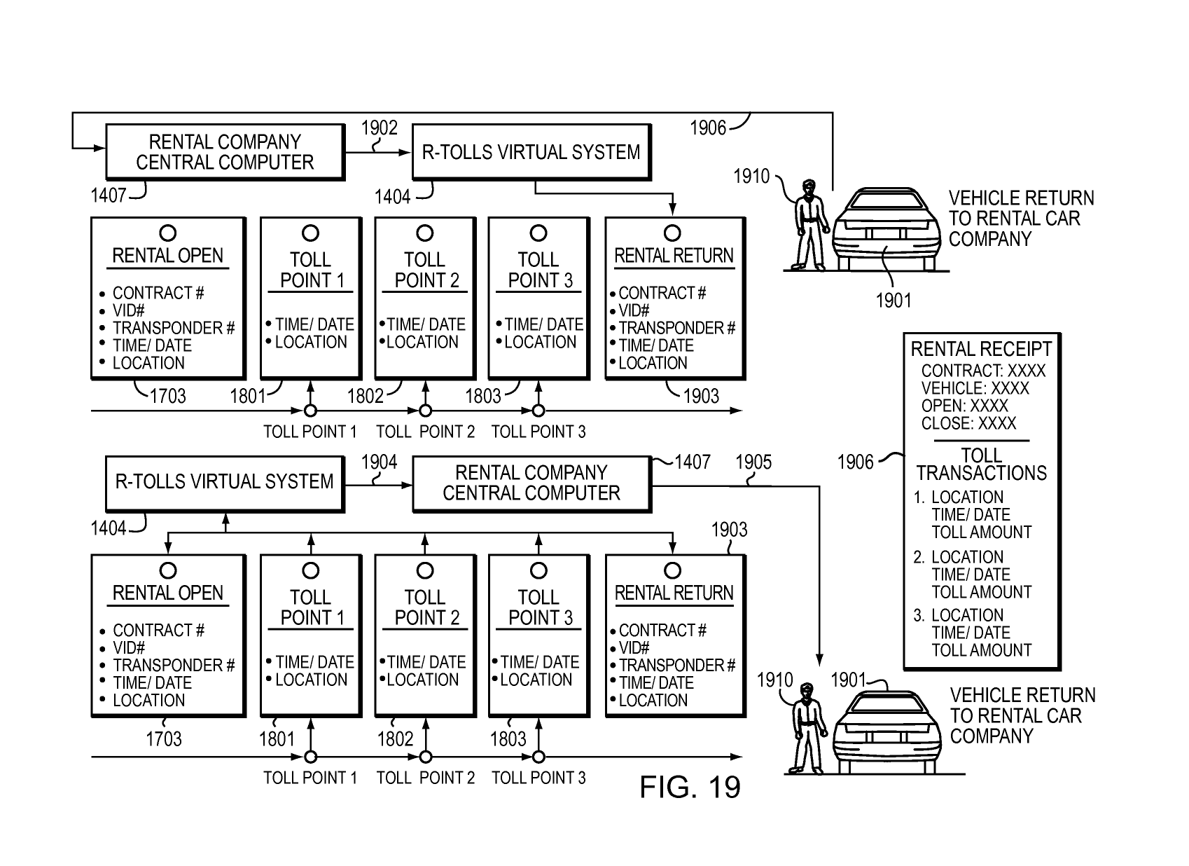

FIG. 19 shows activities at the time of rental vehicle return according to an embodiment of the present invention. As the rental vehicle 1901 returns to the car rental agency, typically a field attendant 1910 enters the vehicle identification number which sends a message 1906 to the rental car company central computer 1407 soliciting final contract and charge information for that particular vehicle. When this occurs, the central computer system 1407 sends a message to the R-Tolls virtual system 1404 which will generate a “rental close” message 1903 for that particular rental. All toll charges accumulated during that particular rental period would be accumulated and forwarded 1904 by the virtual system 1404 back to the rental car company central computer 1407. This information is added, along with other contract information, by the rental car company central computer system 1407 and returned in a message 1905 to the field computer unit 1910 at the side of the rental car. All toll transaction information, including location, time and date, and toll amount, is included on the rental receipt 1906 and in the total amount charged for the vehicle rental.

Upon completion of the transaction, the rental car company computer will then electronically transfer the total amount of the toll charges, which have been assessed to the toll rental customer, back to the R-Tolls master account system 1401.

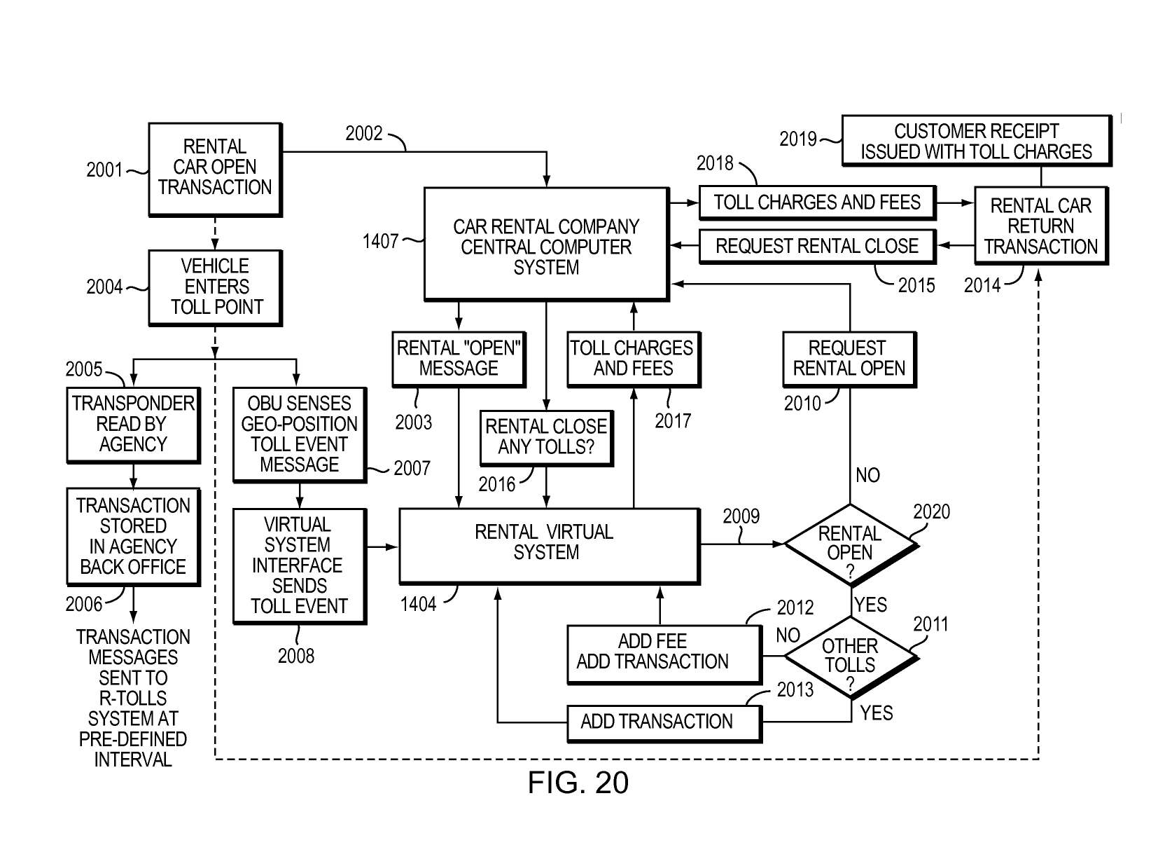

FIG. 20 is a rental tolling flow diagram for the entire process of rental tolling according to an embodiment of the present invention. At the time of the “rental open” transaction 2001a message 2002 is sent to the rental car company central computer system 1407. The rental car company central computer system 1407 sends a message 2003 to the R-Tolls rental virtual system 1404. The virtual system 1404 opens an active file for that particular rental vehicle.

Meanwhile, while the vehicle is in use by the rental customer, if the customer encounters a toll point 2004, parallel transaction processing occurs, similar to that described for the electronic truck tolling program. The transponders on the windshield are read by toll agency equipment 2005 and the transaction is stored in the toll agency's back office system 2006 and eventually sent to the R-Tolls system at pre-determined intervals. The R-Tolls system guarantees payment to the toll agency, and at pre-defined intervals will electronically transfer funds for all valid toll transactions recorded by R-Tolls issued transponders.

In parallel with this, the OBU senses the geo-position of the toll point and generates a toll event message 2007. The virtual system interface obtains that information and forwards it 2008 directly to the rental virtual system 1404. When a virtual toll transaction message is received by the virtual system 1404, it checks to see if a rental file has been opened at 2020. If not, an authorization to open the rental 2010 is sent to the rental car company central computer system 1407. If at 2020 it is determined that a valid rental transaction has already been opened, the system will check to see at step 2011 if there are any prior toll transaction events on that particular record. If there were no prior events, then a one-time fee is added to the record 2012 along with information about the toll transaction itself. If there was prior toll activity on the virtual rental, only the additional transaction is added, without an additional service charge 2013.

When the vehicle is returned 2014, the rental agency service representative triggers a message requesting the central computer system 1407 to close the rental and to forward all charges 2015. The rental car company central computer 1407 then sends a message 2016 to the rental virtual system 1404 requesting any toll charges and fees. The virtual system 1404 responds with that information, if any tolls have been recorded 2017, which will then be included in the total rental car company charges for that particular vehicle. This will then be communicated, along with other information 2018 back to the local rental location and the customer will be issued a receipt which includes all toll charges encountered on the trip 2019. In this described manner, the rental virtual system 1404, maintains a record of the virtual tolling of the rental car throughout each rental transaction and this tolling information is communicated to the rental car company computer 1407 to be used for car rental billing.

Under this system, the rental customer would have to take no action to accept this service. A file is open in the virtual system for all rentals opened by any particular company using the system. If the vehicle encounters no toll facilities during the course of the rental, then no toll charges and no administrative fees are added to the rental agreement charges.

Because the rental car virtual tolling system involves installation of OBUs in each rental vehicle, with two-way communication to/from the OBU interface devices, it is also possible for certain limited, beneficial functions to be performed at the request of the rental car company when needed. These include, but are not necessarily limited to:
a) Vehicle identification service, on demand, which can be used in the event of the non-return of a rental vehicle, stolen rental vehicle or other types of incidents. By communicating with the OBU, it will be possible to identify the location of the rental vehicle at any point in time; and
b) Motorist assistance, such as remote ability to unlock power door locks, which can be used in the event car keys are locked inside the vehicle.

Other rental car tolling services have and can still be provided by others, the proposed national “virtual” electronic toll service program described herein is different in its operation and functionality compared to existing systems. Embodiments of the present invention require no action on the part of the vehicle renter. Further, embodiments of the invention enable all toll charges to be included in the rental transaction cost and included on printed receipts at the time of vehicle return, and would further utilize transponder clusters which would be readable at every participating toll facility in the United States and Canada, not just those operated by local agencies in the vicinity of the vehicle rental. This is of significant value, since many rental vehicles are driven longer distances and may encounter toll facilities operated by different agencies using different technologies.

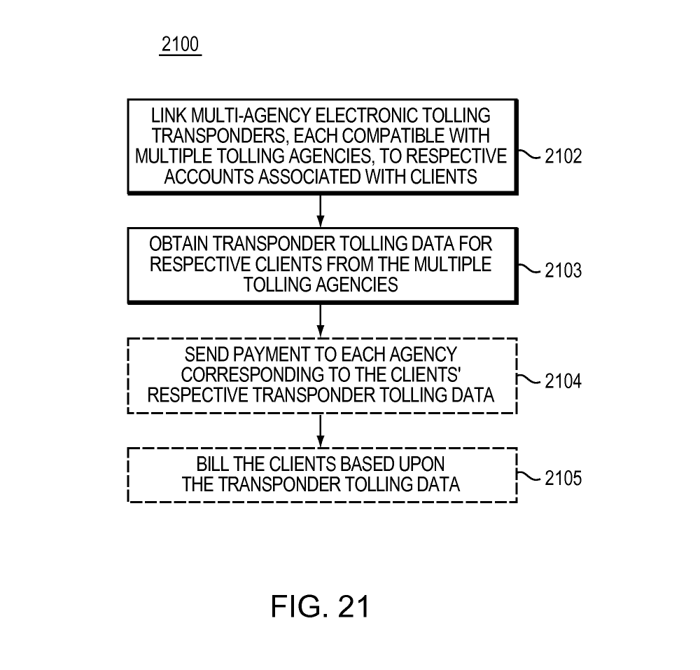

FIG. 21 is a flow diagram of a method 2100 for providing transportation services. The method 2100 begins by linking multi-agency transponders, each compatible with multiple tolling agencies, to respective account associated with clients (2102). In such an embodiment of the method 2100, each multi-agency tolling transponder is compatible with multiple tolling agencies. Thus, the multi-agency tolling transponders may be capable of communication via multiple protocols as described hereinabove. Linking the multi-agency transponder to respective accounts associated with the clients may comprise the establishment and generation of the accounts. Further, multiple clients may be linked to a single account when the clients have requested such a configuration. According to an example embodiment of the method 2100, the transponders are provided for multiple vehicles all belonging to, for example, a single trucking company. In such an example, all the transponders provided to be used in the vehicles owned by that trucking company are linked to a single account that is associated with that trucking company. Another embodiment of the method 2100 further comprises providing the multi-agency transponders.

After linking the accounts of the clients to the multi-agency transponders, the next step is to obtain transponder tolling data for respective clients from the multiple tolling agencies (2103). The transponder tolling data may be obtained through any means as is known in the art. For example, the tolling agency may communicate the tolling data via wireless communications.

The method 2100 may further comprise sending payment to each tolling agency corresponding to the clients' respective transponder tolling data (2104). Further, an alternative embodiment of the method 2100 may comprise billing the clients based upon the transponder tolling data (2105). Thus, embodiments of the method 2100 provide tolling agency interoperability to clients.

In an example embodiment of the method 2100, a client is provided with multiple tolling transponders for each vehicle associated with the client (2101). These multiple transponders are linked to an account associated with the client, 2102 and all transponder tolling data for that client is received from the various tolling agencies that the clients' vehicles pass through (2102). Upon receipt of the transponder tolling agency data, a service provider who performs the method 2100 sends payment to each tolling agency that corresponds to the clients' respective transponder tolling data, 2104 and the client is then billed for these payments (2105).

Alternative embodiments of the method 2100 may further comprise geo-positional tolling. In such an embodiment, the method 2100 further comprises obtaining the clients' respective geo-positional tolling data from respective geo-positional tracking devices that are associated with the clients. Because of the transponder tolling data, the clients tolling data may also be reconciled. In such an embodiment, the respective geo-positional tolling data and the respective transponder tolling data are compared and the respective geo-positional tolling data and the respective transponder tolling data are reconciled. In such an embodiment, reconciling the tolling data may comprise notifying the clients when the respective geo-positional tolling data and the respective transponder tolling data do not correspond and also notifying the tolling agencies when there is not a correspondence between the geo-positional tolling data and the transponder tolling data.

According to an embodiment of the method 2100, the geo-positional tolling data may be obtained through any method as is known in the art. Further the geo-positional tolling data may be obtained by communicating with transportation management systems associated with the clients.

While embodiments of the method 2100 describe billing the clients based upon transponder tolling data, embodiments of the present invention are not so limited and clients may be billed based upon the geo-positional tolling data as well. Billing clients upon the geo-positional tolling data may be advantageous because such billing may occur closer to real-time in comparison to transponder tolling data which is typically delayed.

Embodiments of the method 2100 may further provide weigh station by-pass as described hereinabove. In such an embodiment, the method 2100 further comprises receiving notifications from geo-positional tracking devices that the clients are approaching respective weigh stations. In response to receiving such notifications, the method further comprises sending respective requests to each weigh station for weigh station by-pass, receiving a response to each request for weigh station by-pass and sending each respective response to the respective clients. Thus, the respective clients are made aware of each weigh stations' decision.

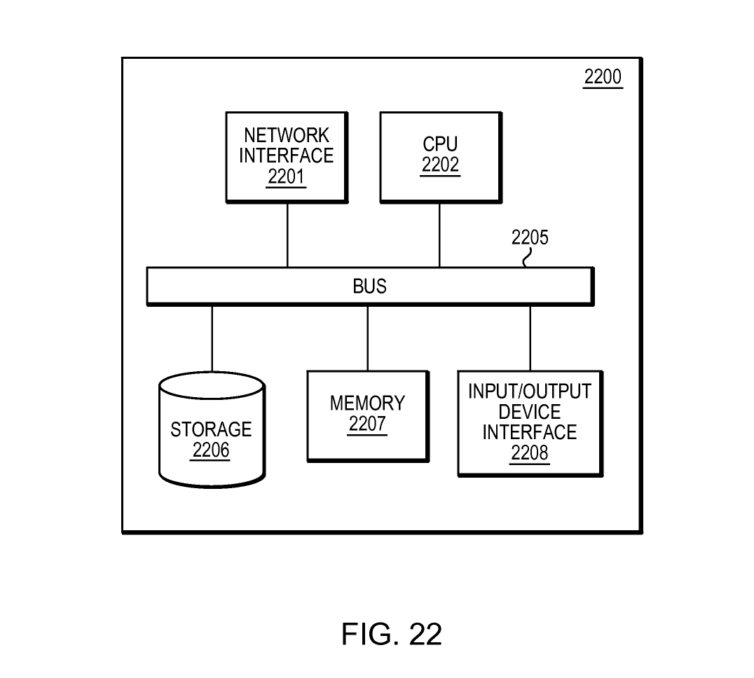

FIG. 22 is a high-level block diagram of a computer system 2200 in which embodiments of the present invention may be embodied. The system 2200 contains a bus 2205. The bus 2205 is a connection between the various components of the system 2200. Connected to the bus 2205 is an input-output device interface 2208 for connecting various input and output devices, such as a keyboard, mouse, display, speakers, etc. to the system 2200. A central processing unit (CPU) 2202 is connected to the bus 2205 and provides for the execution of computer instructions. Memory 2207 provides volatile storage for data used for carrying out computer instructions. Disk storage 2206 provides nonvolatile storage for computer instructions, such as an operating system not shown. The system 2200 further comprises a network interface 2201 for connecting to any variety of networks as are known in the art, including LANs and WANs.

The system 2200 may further comprise various modules that may be used to perform and implement embodiments of the present invention. Further, while the embodiments of the present invention are described as being implemented using various modules, the actual configurations used to implement the various embodiments may be performed according to any methods known in the art. For example, modules may be combined and/or implemented via distributed methods. In such a way, various components of a module may be carried out throughout various components of a system configured to carryout embodiments of the present invention. Further embodiments of the system 2200 may be configured to comprise other modules or any variety of modules in combination to perform weigh station by-pass as described herein. According to an embodiment of the system 2200, the modules as described herein may be software modules that may be executed by a processor such as the CPU 2202. In such an embodiment, the software “modules” may be combined and/or carried out in a distributed manner in a system implementing an embodiment of the present invention.

According to an embodiment of the system 2200, the system further comprises an accounts module that associates accounts with multiple clients and a transponder tolling module configured to obtain clients' respective transponder tolling data from multiple tolling agencies. The system 2200 may also be configured to communicate with multi-agency tolling transponders that are associated with various clients. The system 2200 may further comprise a payment module configured to send payment to each agency corresponding to the clients transponder tolling data and a billing module configured to bill the clients based upon the transponder tolling data. In yet another embodiment of the system 2200, the system 2200 further comprises a geo-positional tolling module configured to obtain the clients' respective geo-positional tolling data from respective geo-positional tracking devices. The system 2200 may further comprise a comparison module configured to compare the respective geo-positional tolling data and the respective transponder tolling data. Yet further still, the system 2200 may comprise a reconciling module configured to reconcile the respective geo-positional tolling data and the respective transponder tolling data. According to such an embodiment of the present invention, the reconciling module is configured to reconcile the respective geo-positional tolling data and respective transponder tolling data by performing at least one of: notifying the clients when the respective geo-positional tolling data and the respective transponder tolling data do not correspond and notifying each agency when the respective geo-positional tolling data and respective transponder tolling data do not correspond.

A further embodiment of the present invention is directed to a vehicle. According to such an embodiment, the vehicle comprises electronics configured to store geo-positional locations of tolling points. In other words, store the location of tolls on highways. Further, the electronics may be configured to use the stored geo-positional locations of tolling points to determine the occurrence of tolling events. Thus, when the vehicle moves past tolling points and the electronics determine the occurrence of a tolling event. In an alternative embodiment of the vehicle, the electronics are further configured to store data related to the vehicle. For example, this data may include the vehicle type, the vehicle size, the vehicle weight and other data such as the number of axles. The electronics may be further configured to use the stored vehicle data to determine the cost of the tolling events.

Another embodiment of the present invention is configured to provide tolling services without using multi-agency tolling transponders. In such an embodiment, traditional electronic tolling methods may be used in conjunction with geo-positional tolling to provide tolling reconciliation. According to such an embodiment, a method comprises, linking tolling transponders to respective accounts associated with clients, and obtaining transponder tolling data for the respective clients. Such an embodiment further comprises obtaining the clients' respective geo-positional tolling data from respective geo-positional tracking devices, comparing the respective geo-positional tolling data, and respective transponder tolling data, and reconciling the respective geo-positional tolling data and the respective transponder tolling data.

Another embodiment of the present invention provides geo-positional tolling by utilizing a TMS system. According to such an embodiment, a method according to the principles of such an embodiment comprises: receiving geo-positional data from a TMS system that communicates with individual vehicles. Next, tolling events are determined based upon the geo-positional data. In such an embodiment, the TMS may be as described hereinabove. Further, the TMS system may receive the geo-positional data from OBUs associated with individual vehicles.

It should be understood that the example embodiments described above may be implemented in many different ways. In some instances, the various methods and machines described herein may each be implemented by a physical, virtual, or hybrid general purpose computer, or a computer network environment.

Embodiments or aspects thereof may be implemented in the form of hardware, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It also should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and, thus, the data processors described herein are intended for purposes of illustration only and not as a limitation of the embodiments.

While this invention has been particularly shown and described with references to example embodiments thereof, it will be understood by those skilled in the art that various changes in form and details may be made therein without departing from the scope of the invention encompassed by the appended claims.

What is claimed is:

1. A method for providing transportation services, the method comprising:
linking multi-agency electronic toll transponders, each compatible with multiple tolling agencies, to respective accounts associated with clients; and
obtaining transponder tolling data for respective clients from the multiple tolling agencies.

2. The method of claim 1 further comprising:
sending payment to each agency corresponding to the clients' respective transponder tolling data; and
billing the clients based upon the transponder tolling data.

3. The method of claim 1 further comprising:
obtaining the clients' respective geo-positional tolling data from respective geo-positional tracking devices; and
reconciling the respective geo-positional tolling data and the respective transponder tolling data.

4. The method of claim 3 wherein reconciling the respective geo-positional tolling data and the respective transponder tolling data comprises at least one of:
notifying the clients when the respective geo-positional tolling data and the respective transponder tolling data do not correspond; and
notifying each agency when the respective geo-positional tolling data and the respective transponder tolling data do not correspond.

5. The method of claim 3 wherein obtaining the clients' geo-positional tolling data comprises:
communicating with transportation management systems associated with the clients.

6. The method of claim 1 further comprising:
obtaining the clients' respective geo-positional tolling data from respective geo-positional tracking devices; and
billing the clients based upon the respective geo-positional tolling data.

7. The method claim 1 further comprising:
receiving notifications from geo-positional tracking devices that the clients are approaching respective weigh stations;
sending respective requests to each weigh station for weigh station by-pass;
receiving a respective response to each request for weigh station by-pass; and
sending each respective response to the respective clients.

8. The method of claim 7 wherein receiving notifications from geo-positional tracking devices comprises:
communicating with transportation management systems associated with clients.

9. The method of claim 1 wherein the multi-agency compatible electronic toll transponders are capable of communication via multiple protocols.

10. A system for providing transportation services, the system comprising:
respective accounts linked to multi-agency electronic tolling transponders, each compatible with multiple tolling agencies, associated with clients; and
a transponder tolling module configured to obtain the clients' respective transponder tolling data from the multiple tolling agencies.

11. The system of claim 10 further comprising:
a payment module configured to send payment to each agency corresponding to the clients' transponder tolling data; and
a billing module configured to bill the clients based upon the transponder tolling data.

12. The system of claim 10 further comprising:
a geo-positional tolling module configured to obtain the clients' respective geo-positional tolling data from respective geo-positional tracking devices; and
a reconciling module configured to reconcile the respective geo-positional tolling data and the respective transponder tolling data.

13. The system of claim 12 wherein the reconciling module is configured to reconcile the respective geo-positional tolling data and the respective transponder tolling data by performing at least one of:
notifying the clients when the respective geo-positional tolling data and the respective transponder tolling data do not correspond; and
notifying each agency when the respective geo-positional tolling data and the respective transponder tolling data do not correspond.

14. The system of claim 12 wherein the geo-positional tolling module is configured to obtain the clients geo-positional tolling data by communicating with transportation management systems associated with the clients.

15. The system of claim 10 further comprising:
a geo-positional tolling module configured to obtain the clients' respective geo-positional tolling data from respective geo-positional tracking devices; and
a billing module configured to bill the clients based upon the respective geo-positional tolling data.

16. The system of claim 10 further comprising:
an approach notification module configured to receive notifications from respective geo-positional tracking devices that the clients are approaching respective weigh stations;
a by-pass unit configured to send respective requests to each weigh station for weigh station by-pass; and
the by-pass unit further configured to receive a respective response to each request for weigh station by-pass and to send each respective response to the respective clients.

17. The system of claim 16 wherein the approach notification module is configured to receive the notification by communicating with transportation management systems associated with the clients.

18. The system of claim 10 wherein the multi-agency compatible electronic tolling transponders are capable of communication via multiple protocols.

19. A non-transitory computer readable medium having stored thereon a sequence of instructions which, when loaded and executed by a processor coupled to an apparatus, causes the apparatus to:
link multi-agency electronic tolling transponders, each compatible with multiple tolling agencies, to respective accounts associated with clients; and
obtain transponder tolling data for respective clients from the multiple tolling agencies.

20. The non-transitory computer readable medium of claim 19 wherein the sequence of instructions which, when loaded and executed by the processor coupled to the apparatus further causes the apparatus to:
send payment to each agency corresponding to the clients' transponder tolling data; and
bill the clients' based upon the transponder tolling data.

21. The non-transitory computer readable medium of claim 19 wherein the sequence of instructions which, when loaded and executed by the processor coupled to the apparatus further causes the apparatus to:
obtain the clients' respective geo-positional tolling data from respective geo-positional tracking devices; and
reconcile the respective geo-positional tolling data and the respective transponder tolling data.

22. The non-transitory computer readable medium of claim 19 wherein the sequence of instructions which, when loaded and executed by the processor coupled to the apparatus further causes the apparatus to:
obtain the clients' respective geo-positional tolling data from respective geo-positional tracking devices; and
bill the clients based upon the respective geo-positional tolling data.

23. A vehicle comprising electronics configured to:
store geo-positional locations of tolling points; and
use the stored geo-positional locations of tolling points to determine the occurrence of tolling events.

24. The vehicle of claim 23 wherein the electronics are further configured to:
store data related to the vehicle; and
use the data related to the vehicle to determine a cost of the tolling events.

25. A method for providing transportation services, the method comprising:
linking electronic tolling transponders to respective accounts associated with clients;
obtaining transponder tolling data for the respective clients;
obtaining the clients' respective geo-positional tolling data from respective geo-positional tracking devices; and
reconciling the respective geo-positional tolling data and the respective transponder tolling data.

26. A method for providing transportation services, the method comprising:
receiving geo-positional data from a transportation management system (TMS) that communicates with individual vehicles; and
determining tolling events based upon the geo-positional data.

27. The method of claim 26 wherein the TMS receives the geo-positional data from on-board units (OBUs) associated with the individual vehicles.

28. A method for providing transportation services, the method comprising:
receiving notifications from geo-positional tracking devices that clients are approaching respective weigh stations;
sending respective requests to each weigh station for weigh station by-pass;
receiving a respective response to each request for weigh station by-pass; and
sending each respective response to the respective clients.

29. The method of claim 28 wherein the geo-positional tracking devices are on-board units associated with vehicles.
